(19) United States
(12) Patent Application Publication
(10) Pub. No.: US 2024/0348977 A1
(43) Pub. Date: Oct. 17, 2024

(54) ELECTRONIC DEVICE, PROGRAM, AND SYSTEM

(71) Applicant: KYOCERA CORPORATION, Kyoto (JP)

(72) Inventors: Takayuki ARAKAWA, Yokohama-shi, Kanagawa (JP); Takeshi SUGIMOTO, Asaka-shi, Saitama (JP); Tsunehiko KAMACHI, Yokohama-shi, Kanagawa (JP); Osamu HOSHUYAMA, Kawasaki-shi, Kanagawa (JP); Edwardo Arata YAMAMOTO MURAKAMI, Kawasaki-shi, Kanagawa (JP); Hideyuki KIMPARA, Yokohama-shi, Kanagawa (JP)

(73) Assignee: KYOCERA Corporation, Kyoto (JP)

(21) Appl. No.: 18/579,244

(22) PCT Filed: Jul. 6, 2022
(86) PCT No.: PCT/JP2022/026874

§ 371 Date: Jan. 12, 2024

(30) Foreign Application Priority Data
Jul. 13, 2021 (JP) 2021-116005

(51) Int. Cl. H04R 3/12; H04R 1/40

(52) U.S. Cl. CPC H04R 3/12; H04R 1/403; H04R 2430/01

(57) ABSTRACT

An electronic device includes a communicator, a sound outputter, and a controller. The communicator communicates with a terminal of a human speaker and communicates with another electronic device that outputs at least one of a predetermined auditory effect or a predetermined visual effect. The sound outputter outputs an audio signal of the human speaker that the communicator receives from the terminal of the human speaker as sound of the human speaker. The controller sets a volume of the sound that the sound outputter outputs. The controller controls the other electronic device to output at least one of the auditory effect or the visual effect when a level of the sound at a position of a candidate that is to be a recipient of the sound is changed at the terminal of the human speaker.

### CROSS-REFERENCE TO RELATED APPLICATIONS

This application claims priority based on Japanese Patent Application No. 2021-116005 filed Jul. 13, 2021, the entire disclosure of which is hereby incorporated by reference.

### TECHNICAL FIELD

The present disclosure relates to an electronic device, a program, and a system.

### BACKGROUND OF INVENTION

Recently, the technology referred to as remote conferencing, such as web conferencing or video conferencing, has become increasingly common. Remote conferencing involves the use of electronic devices (or systems that include electronic devices) to achieve communication among participants located in multiple places. As an example, suppose a scenario in which a meeting is to be held in an office, and at least one of the meeting participants uses remote conferencing to join the meeting remotely from home. In this situation, audio and/or video of the meeting in the office is acquired by an electronic device installed in the office, for example, and transmitted to an electronic device installed in the home of the participant, for example. Audio and/or video in the home of the participant is acquired by an electronic device installed in the home of the participant, for example, and transmitted to an electronic device installed in the office, for example. Such electronic devices allow the meeting to take place without having all participants gather at the same location.

The related art has proposed a variety of technologies that could be applied to remote conferencing as described above. For example, Patent Literature 1 discloses a device that displays a graphic superimposed on an image captured by a camera. The graphic represents the output range of directional sound outputted by a speaker. This device enables a user to visually understand the output range of directional sound.

### CITATION LIST

### Patent Literature

Patent Literature 1: Japanese Unexamined Patent Application Publication No. 2010-21705

### SUMMARY

According to one embodiment, an electronic device includes a communicator, a sound outputter, and a controller. The communicator communicates with a terminal of a human speaker and communicates with another electronic device that outputs at least one of a predetermined auditory effect or a predetermined visual effect. The sound outputter outputs an audio signal of the human speaker that the communicator receives from the terminal as sound of the human speaker. The controller sets a volume of the sound that the sound outputter outputs. The controller controls the other electronic device to output at least one of the auditory effect or the visual effect when a level of the sound at a position of a candidate that is to be a recipient of the sound is changed at the terminal.

According to one embodiment, a program causes an electronic device to execute the following:
communicating with a terminal of a human speaker;
communicating with another electronic device that outputs at least one of a predetermined auditory effect or a predetermined visual effect;
outputting an audio signal of the human speaker received from the terminal as sound of the human speaker;
setting a volume of the sound to be outputted in the outputting step; and
controlling the other electronic device to output at least one of the auditory effect or the visual effect when a level of the sound at a position of a candidate that is to be a recipient of the sound is changed at the terminal.

According to one embodiment, an electronic device includes a communicator, an outputter, and a controller. The communicator communicates with another electronic device that outputs sound of a human speaker. The outputter outputs at least one of a predetermined auditory effect or a predetermined visual effect. The controller controls the outputter to output at least one of the auditory effect or the visual effect on a basis of a request from the other electronic device.

According to one embodiment, a program causes an electronic device to execute the following:
communicating with another electronic device that outputs sound of a human speaker;
outputting at least one of a predetermined auditory effect or a predetermined visual effect; and
causing at least one of the auditory effect or the visual effect to be outputted in the outputting step on a basis of a request from the other electronic device.

According to one embodiment, a system includes first and second electronic devices capable of communicating with one another.

The first electronic device includes a sound outputter and a controller. The sound outputter outputs an audio signal of a human speaker received from a terminal of the human speaker as sound of the human speaker. The controller sets a volume of the sound that the sound outputter outputs. The controller controls the second electronic device to output at least one of a predetermined auditory effect or a predetermined visual effect when a level of the sound at a position of a candidate that is to be a recipient of the sound is changed at the terminal.

The second electronic device includes an outputter and a controller. The outputter outputs at least one of a predetermined auditory effect or a predetermined visual effect. The controller controls the outputter to output at least one of the auditory effect or the visual effect on a basis of a request from the first electronic device.

According to one embodiment, a system includes a first electronic device, a second electronic device, and a terminal of a human speaker.

The terminal and the first electronic device are configured to communicate with one another. The first electronic device and the second electronic device are configured to communicate with one another.

The first electronic device includes a sound outputter and a controller. The sound outputter outputs an audio signal of a human speaker received from the terminal as sound of the human speaker. The controller sets a volume of the sound that the sound outputter outputs. The controller controls the second electronic device to output at least one of a predetermined auditory effect or a predetermined visual effect when a level of the sound at a position of a candidate that is to be a recipient of the sound is changed at the terminal.

The second electronic device includes an outputter and a controller. The outputter outputs at least one of a predetermined auditory effect or a predetermined visual effect. The controller controls the outputter to output at least one of the auditory effect or the visual effect on a basis of a request from the first electronic device.

The terminal includes a sound pickup and a controller. The sound pickup picks up sound of the human speaker. The controller performs control to transmit an audio signal of the human speaker to the first electronic device and to transmit, to the first electronic device, input for changing a level of the sound at a position of a candidate that is to be a recipient of the sound.

According to one embodiment, an electronic device is capable of communicating with each of a terminal of a human speaker, a first electronic device that outputs an audio signal of the human speaker as sound of the human speaker, and a second electronic device that outputs at least one of a predetermined auditory effect or a predetermined visual effect.

The electronic device includes a controller that sets a volume of the sound that the first electronic device outputs.

When a level of the sound at a position of a candidate that is to be a recipient of the sound is changed at the terminal, the controller changes, or leaves unchanged, the volume of the sound, controls the first electronic device to output the sound, and controls the second electronic device to output at least one of the auditory effect or the visual effect.

According to one embodiment, a program causes an electronic device to execute the following:
communicating with a terminal of a human speaker, a first electronic device that outputs an audio signal of the human speaker as sound of the human speaker, and a second electronic device that outputs at least one of a predetermined auditory effect or a predetermined visual effect;
setting a volume of the sound that the first electronic device outputs;
changing, or leaving unchanged, the volume of the sound when a level of the sound at a position of a candidate that is to be a recipient of the sound is changed at the terminal;
controlling the first electronic device to output the sound; and
controlling the second electronic device to output at least one of the auditory effect or the visual effect.

According to one embodiment, a system includes a terminal of a human speaker, a first electronic device, a second electronic device, and a third electronic device.

The third electronic device is configured to communicate with the terminal, the first electronic device, and the second electronic device.

The terminal includes a sound pickup and a controller. The sound pickup picks up sound of the human speaker. The controller performs control to transmit an audio signal of the human speaker to the third electronic device and to transmit, to the third electronic device, input for changing a level of the sound at a position of a candidate that is to be a recipient of the sound.

The first electronic device includes a sound outputter that outputs an audio signal of a human speaker received from the terminal as sound of the human speaker.

The second electronic device includes an outputter and a controller. The outputter outputs at least one of a predetermined auditory effect or a predetermined visual effect. The controller controls the outputter to output at least one of the auditory effect or the visual effect on a basis of a request from the third electronic device.

The third electronic device includes a controller that sets a volume of the sound that the first electronic device outputs. When a level of the sound at a position of a candidate that is to be a recipient of the sound is changed at the terminal, the controller changes, or leaves unchanged, the volume of the sound, controls the first electronic device to output the sound, and controls the second electronic device to output at least one of a predetermined auditory effect or a predetermined visual effect.

### BRIEF DESCRIPTION OF THE DRAWINGS

FIG. 1 is a diagram illustrating an example of a usage scenario of a system including first/second electronic devices and a terminal according to one embodiment.

FIG. 2 is a function block diagram schematically illustrating a configuration of the first electronic device according to one embodiment.

FIG. 3 is a function block diagram schematically illustrating a configuration of the terminal according to one embodiment.

FIG. 4 is a flowchart for describing operations by the first electronic device according to one embodiment.

FIG. 5 is a diagram illustrating an example of image capture by an electronic device according to one embodiment.

FIG. 6 is a diagram illustrating an example of display by the terminal according to one embodiment.

FIG. 7 is a flowchart for describing operations by the second electronic device according to one embodiment.

FIG. 8 is a flowchart for describing operations by the first electronic device according to one embodiment.

FIG. 9 is a diagram illustrating an example of display by the terminal according to one embodiment.

FIG. 10 is a diagram illustrating an example of display by the terminal according to one embodiment.

FIG. 11 is a flowchart for describing operations by the first electronic device according to one embodiment.

FIG. 12 is a flowchart for describing operations by the second electronic device according to one embodiment.

FIG. 13 is a diagram illustrating an example of display by the terminal according to one embodiment.

FIG. 14 is a function block diagram schematically illustrating a configuration of the second electronic device according to another embodiment.

FIG. 15 is a function block diagram schematically illustrating a configuration of the second electronic device according to another embodiment.

FIG. 16 is a diagram illustrating an example of a usage scenario of a system including a first electronic device, a second electronic device, a terminal, and a server or the like according to one embodiment.

FIG. 17 is a function block diagram schematically illustrating a configuration of the server or the like illustrated in FIG. 16.

### DESCRIPTION OF EMBODIMENTS

In the present disclosure, an “electronic device” may be a device driven by electricity supplied from a power system or a battery, for example. In the present disclosure, a “user” may be an entity (typically a person) that uses, or could use, an electronic device according to one embodiment. A “user” may also be an entity that uses, or could use, a system including an electronic device according to one embodiment. In the present disclosure, “remote conferencing” is a general term for conferencing such as web conferencing or video conferencing, in which at least one participant joins by communication from a different location from the other participant(s).

Further improvement in functionality is desirable for an electronic device that enables communication between multiple locations in remote conferencing and the like. An objective of the present disclosure is to improve the functionality of an electronic device, a program, and a system that enable communication between multiple locations. According to one embodiment, improvement in functionality is possible for an electronic device, a program, and a system that enable communication between multiple locations. The following describes an electronic device according to one embodiment in detail, with reference to the drawings.

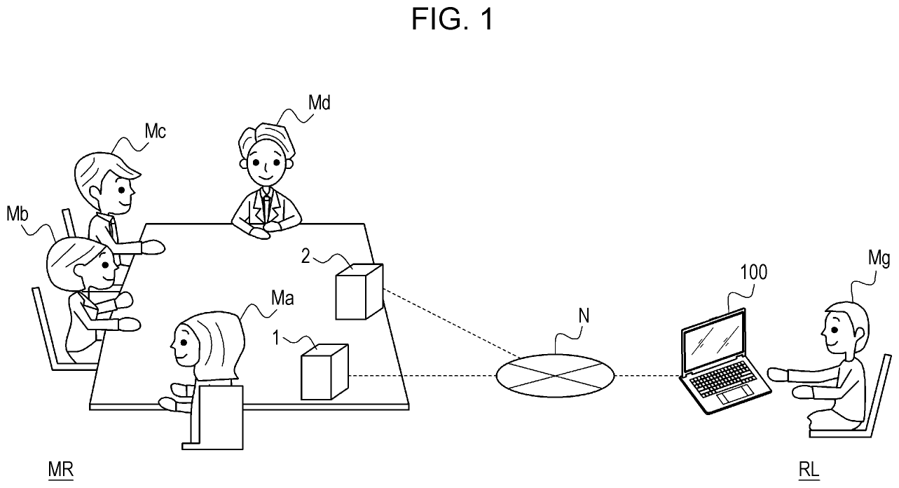

FIG. 1 is a diagram illustrating an example of a usage scenario of an electronic device according to one embodiment. As illustrated in FIG. 1, the following description assumes a scenario in which a meeting takes places in a meeting room MR, and a participant Mg joins the meeting remotely from a home RL. As illustrated in FIG. 1, participants Ma, Mb, Mc, and Md are assumed to join the meeting in the meeting room MR. The meeting participants are not limited to the participants Ma, Mb, Mc, and Md, and other participants may also join in, such as participants Me and Mf, for example.

As illustrated in FIG. 1, a first electronic device 1 according to one embodiment may be installed in the meeting room MR. A second electronic device 2 according to one embodiment may also be installed in the meeting room MR. On the other hand, a terminal 100 that communicates with the first electronic device 1 according to one embodiment may be installed in the home RL of the participant Mg. The home RL of the participant Mg may be in a different location from the meeting room MR. The home RL of the participant Mg may be in a location distant from the meeting room MR or close to the meeting room MR.

The present disclosure is described mainly from the perspective of the first electronic device 1, referring to the first electronic device 1 as the “electronic device” and the second electronic device as the “other electronic device”. However, the present disclosure may also be described mainly from the perspective of the second electronic device 2, referring to the second electronic device as the “electronic device” and the first electronic device 1 as the “other electronic device”.

As illustrated in FIG. 1, the first electronic device 1 according to one embodiment is connected to the terminal 100 according to one embodiment through a network N, for example. The first electronic device 1 according to one embodiment is connected to the terminal 100 according to one embodiment in at least one of a wired or wireless way. In other words, in one embodiment, the first electronic device 1 may be configured to communicate with the terminal 100. FIG. 1 uses dashed lines to illustrate the state of wired and/or wireless connection between the first electronic device 1 and the terminal 100 through the network N.

As illustrated in FIG. 1, the second electronic device 2 according to one embodiment is connected to the first electronic device 1 according to one embodiment through the network N, for example. The second electronic device 2 according to one embodiment is connected to the first electronic device 1 according to one embodiment in at least one of a wired or wireless way. In other words, in one embodiment, the second electronic device 2 may be configured to communicate with the first electronic device 1. FIG. 1 uses dashed lines to illustrate the state of wired and/or wireless connection between the second electronic device 2 and the first electronic device 1 through the network N. In one embodiment, the second electronic device 2 may be connected to the first electronic device 1 without going through the network N. In other words, the first electronic device 1 and the second electronic device 2 may be connected to one another directly in at least one of a wired or wireless way.

In one embodiment, a remote conferencing system may include the first electronic device 1, the second electronic device 2, and the terminal 100.

In the present disclosure, the network N as illustrated in FIG. 1 may also include, for example, any of various types of electronic devices and/or a device such as a server where appropriate. The network N as illustrated in FIG. 1 may also include, for example, a device such as a base station and/or a relay where appropriate. In the present disclosure, for example, when the first electronic device 1 and the terminal 100 “communicate”, the first electronic device 1 and the terminal 100 may be assumed to communicate directly. As another example, when the second electronic device 2 and the terminal 100 “communicate”, the second electronic device 2 and the terminal 100 may be assumed to communicate directly. As another example, when the first electronic device 1 and the terminal 100 “communicate”, the first electronic device 1 and the terminal 100 may be assumed to communicate via at least one of another device and/or a base station or the like. As another example, when the first electronic device 1 and the terminal 100 “communicate”, more precisely, a communicator of the first electronic device 1 and a communicator of the terminal 100 may be assumed to communicate. In the same and/or similar manner, when the second electronic device 2 and the terminal 100 “communicate”, for example, the second electronic device 2 and the terminal 100 may be assumed to communicate via at least one of another device and/or a base station or the like. As another example, when the second electronic device 2 and the terminal 100 “communicate”, more precisely, a communicator of the second electronic device 2 and a communicator of the terminal 100 may be assumed to communicate.

Expressions like the above may have the same and/or similar intention not only when the first electronic device 1 and/or the second electronic device 2 “communicates” with the terminal 100, but also when one “transmits” information to the other, and/or when the other “receives” information transmitted by the one. Expressions like the above may have the same and/or similar intention not only when the first electronic device 1 and/or the second electronic device 2 “communicates” with the terminal 100, but also when any electronic device communicates with any other electronic device.

The first electronic device 1 according to one embodiment may be placed in the meeting room MR as illustrated in FIG. 1, for example. In this case, the first electronic device 1 may be placed at a position allowing for the acquisition of audio and/or video of at least one among the meeting participants Ma, Mb, Mc, and Md. As described later, the electronic device 1 outputs audio and/or video of the participant Mg. Therefore, the electronic device 1 may be placed so that audio and/or video of the participant Mg outputted from the electronic device 1 reaches at least one among the meeting participants Ma, Mb, Mc, and Md.

The second electronic device 2 according to one embodiment may be placed in the meeting room MR as illustrated in FIG. 1, for example. As described later, the second electronic device 2 outputs a predetermined auditory effect and/or visual effect. Therefore, the second electronic device 2 may be placed so that an auditory effect and/or visual effect outputted from the second electronic device 2 reaches at least one among the meeting participants Ma, Mb, Mc, and Md. In one embodiment, the second electronic device 2 may also function to acquire audio and/or video of at least one among the meeting participants Ma, Mb, Mc, and Md. In this case, the second electronic device 2 may be placed at a position allowing for the acquisition of audio and/or video of at least one among the meeting participants Ma, Mb, Mc, and Md.

The terminal 100 according to one embodiment may be placed in the home RL of the participant Mg in the manner as illustrated in FIG. 1, for example. In this case, the terminal 100 may be placed at a position allowing for the acquisition of audio and/or video of the participant Mg. The terminal 100 may acquire audio and/or video of the participant Mg through a microphone or headset and/or a camera connected to the terminal 100.

As described later, the terminal 100 outputs audio and/or video of at least one among the meeting participants Ma, Mb, Mc, Md, Me, and Mf in the meeting room MR. Therefore, the terminal 100 may be placed so that audio and/or video outputted from the terminal 100 reaches the participant Mg. The terminal 100 may be placed so that sound outputted from the terminal 100 reaches the cars of the participant Mg via a speaker, headphones, carphones, or a headset, for example.

FIG. 1 merely illustrates one example of a usage scenario of the first electronic device 1, the second electronic device 2, and the terminal 100 according to one embodiment. The first electronic device 1, the second electronic device 2, and the terminal 100 according to one embodiment may be used in a variety of other scenarios.

Through the remote conferencing system including the first electronic device 1, the second electronic device 2, and the terminal 100 illustrated in FIG. 1, the participant Mg can act as though they are participating in the meeting taking place in the meeting room MR, while being in the home RL. Through the remote conferencing system including the first electronic device 1, the second electronic device 2, and the terminal 100 illustrated in FIG. 1, the meeting participants Ma, Mb, Mc, and Md can feel as though the participant Mg is actually present in the meeting taking place in the meeting room MR. In other words, in the remote conferencing system including the first electronic device 1, the second electronic device 2, and the terminal 100, the first electronic device 1 placed in the meeting room MR can play the role of an avatar of the participant Mg. In this case, the first electronic device 1 may also function as a physical avatar made to resemble the participant Mg. The first electronic device 1 may also function as a virtual avatar, with the first electronic device 1 displaying an image of the participant Mg or an image showing the participant Mg as a character, for example.

The following describes a functional configuration of the first electronic device 1, the second electronic device 2, and the terminal 100 according to one embodiment.

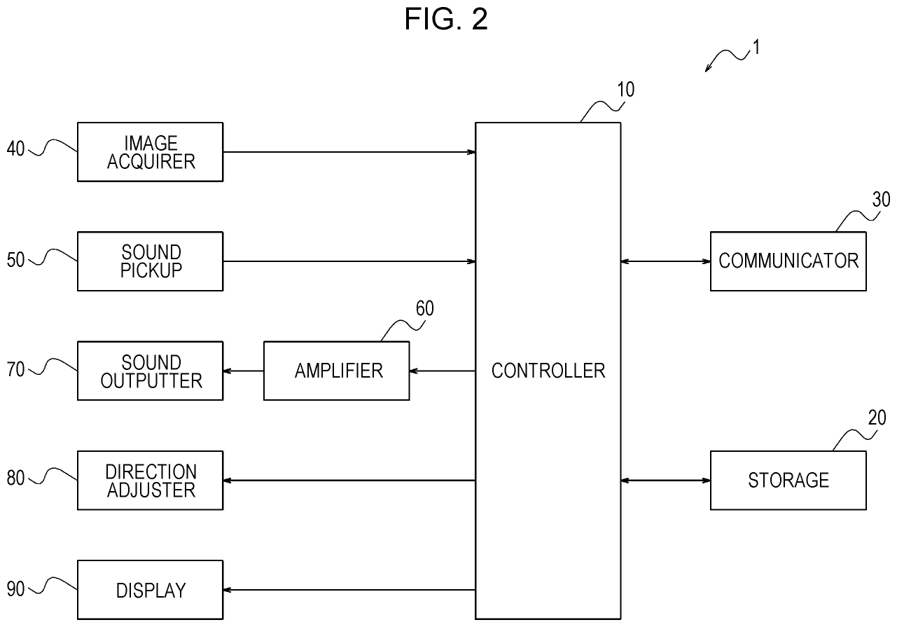

FIG. 2 is a block diagram schematically illustrating a functional configuration of the first electronic device 1 illustrated in FIG. 1. The following describes an example of the configuration of the first electronic device 1 according to one embodiment.

The first electronic device 1 according to one embodiment may be assumed to be any of a variety of devices. For example, the first electronic device 1 may be a device designed for a specific purpose. As another example, the first electronic device 1 according to one embodiment may be a general-purpose device such as a smartphone, tablet, phablet, notebook computer (notebook PC or laptop), or computer (desktop) connected to a device designed for a specific purpose.

As illustrated in FIG. 2, the first electronic device 1 according to one embodiment may include a controller 10, storage 20, a communicator 30, an image acquirer 40, a sound pickup 50, an amplifier 60, a sound outputter 70, a direction adjuster 80, and a display 90. In one embodiment, the first electronic device 1 may include at least some of the functional units illustrated in FIG. 2, and may also include components other than the functional units illustrated in FIG. 2.

The controller 10 controls and/or manages the first electronic device 1 as a whole, including the functional units that form the first electronic device 1. To provide control and processing power for executing various functions, the controller 10 may include at least one processor, such as a central processing unit (CPU) or a digital signal processor (DSP), for example. The controller 10 may be achieved entirely with a single processor, with several processors, or with respectively separate processors. The processor may be achieved as a single integrated circuit (IC). The processor may be achieved as a plurality of communicatively connected integrated circuits and discrete circuits. The processor may be achieved on the basis of various other known technologies.

The controller 10 may include at least one processor and a memory. The processor may include a general-purpose processor that loads a specific program to execute a specific function, and a special-purpose processor dedicated to a specific process. The special-purpose processor may include an application-specific integrated circuit (ASIC). The processor may include a programmable logic device (PLD). The PLD may include a field-programmable gate array (FPGA). The controller 10 may also be a system-on-a-chip (SoC) or a system in a package (SiP) in which one or more processors cooperate. The controller 10 controls the operations of each component of the first electronic device 1.

The controller 10 may include one or both of software and hardware resources, for example. In the first electronic device 1 according to one embodiment, the controller 10 may be configured by specific means in which software and hardware resources work together. The amplifier 60 described below likewise may include one or both of software and hardware resources. In the first electronic device 1 according to one embodiment, at least one other functional unit may be configured by specific means in which software and hardware resources work together.

Control and other operations by the controller 10 in the first electronic device 1 according to one embodiment is further described later.

The storage 20 may function as a memory to store various information. The storage 20 may store, for example, a program to be executed in the controller 10 and the result of a process executed in the controller 10. The storage 20 may function as a working memory of the controller 10. As illustrated in FIG. 2, the storage 20 may be connected to the controller 10 in a wired and/or wireless way. The storage 20 includes at least one of random access memory (RAM) or read-only memory (ROM), for example. The storage 20 can be configured as a semiconductor memory, for example, but is not limited thereto, and can be any storage device. For example, the storage 20 may be a storage medium such as a memory card inserted into the first electronic device 1 according to one embodiment. The storage 20 may also be an internal memory of a CPU to be used as the controller 10. The storage 20 may also be connected to the controller 10 as a separate unit.

The communicator 30 functions as an interface for communicating with an external device or the like in a wired and/or wireless way, for example. The communication scheme carried out by the communicator 30 according to one embodiment may be a wireless communication standard. For example, wireless communication standards include cellular phone communication standards such as 2G, 3G, 4G, and 5G. For example, cellular phone communication standards include Long Term Evolution (LTE), Wideband Code Division Multiple Access (W-CDMA), CDMA2000, Personal Digital Cellular (PDC), the Global System for Mobile Communications (GSM®), and the Personal Handy-phone System (PHS). For example, wireless communication standards include Worldwide Interoperability for Microwave Access (WiMAX), IEEE 802.11, Wi-Fi, Bluetooth®, the Infrared Data Association (IrDA), and near field communication (NFC). The communicator 30 may include a modem that supports a communication scheme standardized by the International Telecommunication Union Telecommunication Standardization Sector (ITU-T), for example. The communicator 30 can support one or more of the above communication standards.

The communicator 30 may include an antenna for transmitting and receiving radio waves and a suitable RF unit, for example. The communicator 30 may use an antenna for instance to communicate wirelessly with a communicator of another electronic device, for example. For example, the communicator 30 may communicate wirelessly with the terminal 100 illustrated in FIG. 1. In this case, the communicator 30 may communicate wirelessly with a communicator 130 (described later) of the terminal 100. In this way, in one embodiment, the communicator 30 functions to communicate with the terminal 100. As another example, the communicator 30 may communicate wirelessly with the second electronic device 2 illustrated in FIG. 1. In this case, the communicator 30 may communicate wirelessly with a communicator 30 (described later) of the second electronic device 2. In this way, in one embodiment, the communicator 30 functions to communicate with the second electronic device 2. The communicator 30 may also be configured as an interface, such as a connector for making a wired connection with external equipment. The communicator 30 can be configured according to known technology for performing wireless communication. Accordingly, a more detailed description of hardware and the like is omitted.

As illustrated in FIG. 2, the communicator 30 may be connected to the controller 10 in a wired and/or wireless way. Various information that the communicator 30 receives may be supplied to the storage 20 and/or the controller 10, for example. The various information that the communicator 30 receives may be stored in a built-in memory of the controller 10, for example. The communicator 30 may also transmit a result of processing by the controller 10 and/or information stored in the storage 20 to external equipment, for example.

The image acquirer 40 may include an image sensor that captures images electronically, such as a digital camera, for example. The image acquirer 40 may include an image sensor that performs photoelectric conversion, such as a charge-coupled device (CCD) image sensor or a complementary metal-oxide-semiconductor (CMOS) sensor. The image acquirer 40 can capture an image of the surroundings of the first electronic device 1, for example. The image acquirer 40 may capture the situation inside the meeting room MR illustrated in FIG. 1, for example. In one embodiment, the image acquirer 40 may capture persons such as the participants Ma, Mb, Mc, and Md of the meeting taking place in the meeting room MR illustrated in FIG. 1, for example.

The image acquirer 40 may convert a captured image into a signal and transmit the signal to the controller 10. Accordingly, the image acquirer 40 may be connected to the controller 10 in a wired and/or wireless way. A signal based on an image captured by the image acquirer 40 may also be supplied to a functional unit of the first electronic device 1, such as the storage 20 or the display 90. The image acquirer 40 is not limited to an image capture device such as a digital camera, and may be any device capable of capturing the situation inside the meeting room MR illustrated in FIG. 1.

In one embodiment, the image acquirer 40 may, for example, capture the situation inside the meeting room MR as still images at intervals of a predetermined time (such as 15 frames per second, for example). In one embodiment, the image acquirer 40 may, for example, capture the situation inside the meeting room MR as a continuous moving image. The image acquirer 40 may include a fixed-point camera or a movable camera.

The sound pickup 50 detects sound or speech, including human vocalizations, around the first electronic device 1. For example, the sound pickup 50 may detect sound or speech as air vibrations via a diaphragm, for example, and convert the detected air vibrations into an electrical signal. Typically, the sound pickup 50 may include any acoustic device to convert sound into an electrical signal, such as a mike (microphone). In one embodiment, the sound pickup 50 may detect the sound of at least one among the participants Ma, Mb, Mc, and Md in the meeting room MR illustrated in FIG. 1, for example. The sound (electrical signal) detected by the sound pickup 50 may be inputted into the controller 10, for example. Accordingly, the sound pickup 50 may be connected to the controller 10 in a wired and/or wireless way.

The sound pickup 50 may convert collected sound or speech into an electrical signal and supply the electrical signal to the controller 10. The sound pickup 50 may also supply an electrical signal (audio signal) converted from sound or speech to a functional unit of the first electronic device 1, such as the storage 20. The sound pickup 50 may be any device capable of detecting sound or speech inside the meeting room MR illustrated in FIG. 1.

The amplifier 60 appropriately amplifies the electrical signal (audio signal) of sound or speech supplied from the controller 10, and supplies an amplified signal to the sound outputter 70. The amplifier 60 may include any device that functions to amplify an electrical signal, such as an amp. The amplifier 60 may amplify an electrical signal (audio signal) of sound or speech according to an amplification factor set by the controller 10. The amplifier 60 may be connected to the controller 10 in a wired and/or wireless way.

In one embodiment, the amplifier 60 may amplify an audio signal that the communicator 30 receives from the terminal 100. The audio signal received from the terminal 100 may be an audio signal of a human speaker (for example, the participant Mg illustrated in FIG. 1) that the communicator 30 receives from the terminal 100 used by the human speaker.

The sound outputter 70 outputs sound or speech by converting into sound an electrical signal (audio signal) appropriately amplified by the amplifier 60. The sound outputter 70 may be connected to the amplifier 60 in a wired and/or wireless way. The sound outputter 70 may include any device that functions to output sound, such as a speaker (loudspeaker). In one embodiment, the sound outputter 70 may include a directional speaker that conveys sound in a specific direction. The sound outputter 70 may also be capable of changing the directivity of sound.

In one embodiment, the sound outputter 70 may output an audio signal of a human speaker (for example, the participant Mg illustrated in FIG. 1) amplified by the amplifier 60 as sound of the human speaker.

The direction adjuster 80 functions to adjust the direction of sound or speech outputted by the sound outputter 70. The direction adjuster 80 may be controlled by the controller 10 to adjust the direction of sound or speech outputted by the sound outputter 70. Accordingly, the direction adjuster 80 may be connected to the controller 10 in a wired and/or wireless way. In one embodiment, the direction adjuster 80 may include a power source and/or power mechanism such as a servo motor that can change the direction of the sound outputter 70, for example.

However, the direction adjuster 80 is not limited to a device that functions to change the direction of the sound outputter 70. For example, the direction adjuster 80 may also function to change the orientation of the entire enclosure of the first electronic device 1. In this case, the direction adjuster 80 may include a power source and/or power mechanism such as a servo motor that can change the orientation of the enclosure of the first electronic device 1. Changing the orientation of the enclosure of the first electronic device 1 allows for changing the direction of the sound outputter 70 provided in the first electronic device 1 as a result. The direction adjuster 80 can also change the orientation of the enclosure of the first electronic device 1 and thereby change the direction of the video (image) captured by the image acquirer 40.

The direction adjuster 80 may also be provided to a device such as a pedestal or trestle on which to place the enclosure of the first electronic device 1. In this case, the direction adjuster 80 likewise may include a power source and/or power mechanism such as a servo motor that can change the orientation of the enclosure of the first electronic device 1. As above, the direction adjuster 80 may function to change the direction or orientation of at least one of the sound outputter 70 or the first electronic device 1.

When the sound outputter 70 includes a directional speaker, for example, the direction adjuster 80 may also function to adjust (change) the directivity of sound or speech outputted by the sound outputter 70.

In one embodiment, the direction adjuster 80 may adjust the direction of sound of a human speaker (for example, the participant Mg illustrated in FIG. 1) outputted by the sound outputter 70. The direction adjuster 80 may include any device insofar as the direction adjuster 80 functions to adjust the direction of sound or speech outputted by the sound outputter 70 as a result. The direction adjuster 80 may adjust the direction of sound in the left-right direction (horizontal direction) and/or the up-down direction (vertical direction), for example.

The display 90 may be a display device of any type, such as a liquid crystal display (LCD), an organic electro-luminescence (EL) panel, or an inorganic electro-luminescence (EL) panel, for example. The display 90 may display various types of information such as characters, figures, or symbols. The display 90 may also display objects, icon images, and the like forming various GUI elements for prompting a user to operate the first electronic device 1, for example.

Various data necessary for displaying information on the display 90 may be supplied from the controller 10 or the storage 20, for example. Accordingly, the display 90 may be connected to the controller 10 or the like in a wired and/or wireless way. When the display 90 includes an LCD, for example, the display 90 may also include a backlight or the like where appropriate.

In one embodiment, the display 90 may display video based on a video signal transmitted from the terminal 100. The display 90 may display video of, for example, the participant Mg captured by the terminal 100 as the video based on a video signal transmitted from the terminal 100. Displaying video of the participant Mg on the display 90 of the first electronic device 1 enables persons such as the participants Ma, Mb, Mc, Md, Me, and Mf illustrated in FIG. 1 to visually understand the situation of the participant Mg in a location away from the meeting room MR, for example.

The display 90 may display unmodified video of the participant Mg captured by the terminal 100, for example. On the other hand, the display 90 may display an image (for example, an avatar) showing the participant Mg as a character, for example.

In one embodiment, the first electronic device 1 may be a device designed for a specific purpose, as described above. On the other hand, in one embodiment, the first electronic device 1 may include the sound outputter 70 and the direction adjuster 80 from among the functional units illustrated in FIG. 2, for example. In this case, the first electronic device 1 may be connected to another electronic device to supplement at least some of the functions of the other functional units illustrated in FIG. 2. The other electronic device may be a general-purpose device such as a smartphone, tablet, phablet, notebook computer (notebook PC or laptop), or computer (desktop), for example.

The second electronic device 2 illustrated in FIG. 1 may have a configuration that is the same as, and/or similar to, the first electronic device 1 illustrated in FIG. 2, for example. In other words, in one embodiment, the first electronic device 1 and the second electronic device 2 may be electronic devices with the same and/or similar configuration. In this case, FIG. 2 may be considered to be a block diagram schematically illustrating not only a functional configuration of the first electronic device 1 illustrated in FIG. 1, but also a functional configuration of the second electronic device 2 illustrated in FIG. 1.

When giving the second electronic device 2 the same and/or similar configuration as the first electronic device 1, the configuration of each functional unit is already explained in FIG. 2. Therefore, a more detailed description is omitted. As described above, the second electronic device 2 is configured to communicate with the first electronic device 1. Accordingly, the communicator 30 of the second electronic device 2 may communicate wirelessly with the first electronic device 1. In this case, the communicator 30 of the second electronic device 2 may communicate wirelessly with the communicator 30 of the first electronic device 1. In this way, in one embodiment, the communicator 30 of the second electronic device 2 functions to communicate with the first electronic device 1.

In another example, the communicator 30 of the second electronic device 2 may communicate wirelessly with the terminal 100 illustrated in FIG. 1. In this case, the communicator 30 of the second electronic device 2 may communicate wirelessly with a communicator 130 (described later) of the terminal 100. In this way, in one embodiment, the communicator 30 of the second electronic device 2 may function to communicate with the terminal 100.

On the other hand, the second electronic device 2 illustrated in FIG. 1 may have a configuration different from the first electronic device 1 illustrated in FIG. 2. In other words, in one embodiment, the first electronic device 1 and the second electronic device 2 may be electronic devices with different configurations. In one embodiment, the second electronic device 2 may be an electronic device that can supplement the functions of the first electronic device 1.

When giving the second electronic device 2 a different configuration from the first electronic device 1, the second electronic device 2 may be, for example, an electronic device including the controller 10, communicator 30, amplifier 60, and sound outputter 70 illustrated in FIG. 2. If necessary, the second electronic device 2 may also include the storage 20, direction adjuster 80, and the like.

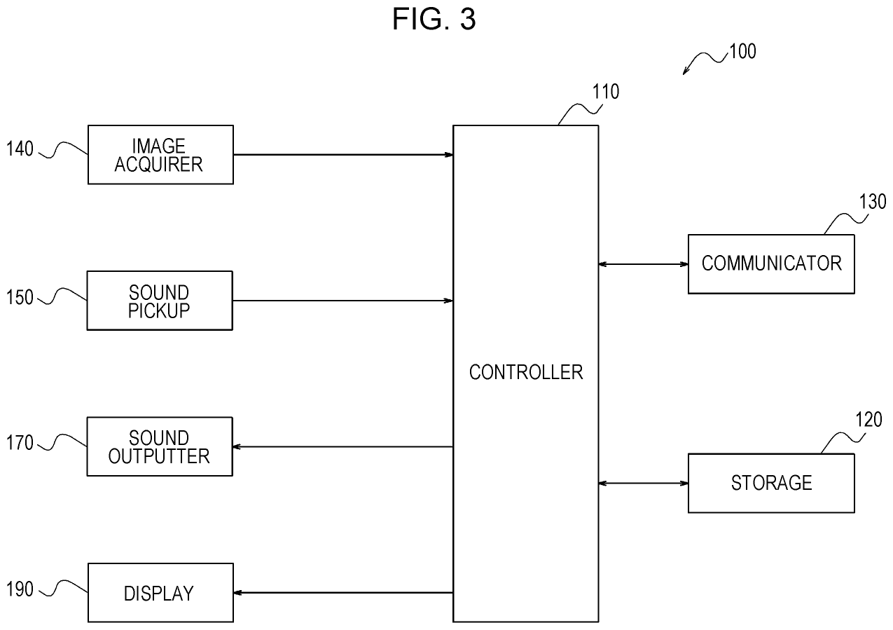

FIG. 3 is a block diagram schematically illustrating a functional configuration of the terminal 100 illustrated in FIG. 1. The following describes an example of the configuration of the terminal 100 according to one embodiment. As illustrated in FIG. 1, the terminal 100 may be a terminal that the participant Mg uses in the home RL, for example. The first electronic device 1 according to one embodiment functions to output sound inputted into the terminal 100 when the participant Mg speaks. Accordingly, in such a scenario, the terminal 100 is also referred to as the “terminal of a human speaker”, as appropriate.

As illustrated in FIG. 3, the terminal 100 according to one embodiment may include a controller 110, storage 120, a communicator 130, an image acquirer 140, a sound pickup 150, a sound outputter 170, and a display 190. In one embodiment, the terminal 100 may include at least some of the functional units illustrated in FIG. 3, and may also include components other than the functional units illustrated in FIG. 3.

The controller 110 controls and/or manages the terminal 100 as a whole, including the functional units that form the terminal 100. Basically, the controller 110 may have a configuration based on the same and/or similar concept as the controller 10 illustrated in FIG. 2, for example.

The storage 120 may function as a memory to store various information. The storage 120 may store, for example, a program to be executed in the controller 110 and the result of a process executed in the controller 110. The storage 120 may function as a working memory of the controller 110. As illustrated in FIG. 3, the storage 120 may be connected to the controller 110 in a wired and/or wireless way. Basically, the storage 120 may have a configuration based on the same and/or similar concept as the storage 20 illustrated in FIG. 2, for example.

The communicator 130 functions as an interface for communicating in a wired and/or wireless way. The communicator 130 may use an antenna for instance to communicate wirelessly with a communicator of another electronic device, for example. For example, the communicator 130 may communicate wirelessly with the first electronic device 1 illustrated in FIG. 1. In this case, the communicator 130 may communicate wirelessly with the communicator 30 of the first electronic device 1. In this way, in one embodiment, the communicator 130 functions to communicate with the first electronic device 1. The communicator 130 may communicate wirelessly with the second electronic device 2 illustrated in FIG. 1, for example. In this case, the communicator 130 may communicate wirelessly with the communicator 30 of the second electronic device 2. In this way, in one embodiment, the communicator 130 may also function to communicate with the second electronic device 2. As illustrated in FIG. 3, the communicator 130 may be connected to the controller 110 in a wired and/or wireless way. Basically, the communicator 130 may have a configuration based on the same and/or similar concept as the communicator 30 illustrated in FIG. 2, for example.

The image acquirer 140 may include an image sensor that captures images electronically, such as a digital camera, for example. The image acquirer 140 may capture the situation inside the home RL illustrated in FIG. 1, for example. In one embodiment, the image acquirer 140 may capture the participant Mg who participates in the meeting from the home RL illustrated in FIG. 1, for example. The image acquirer 140 may convert a captured image into a signal and transmit the signal to the controller 110. Accordingly, the image acquirer 140 may be connected to the controller 110 in a wired and/or wireless way. Basically, the image acquirer 140 may have a configuration based on the same and/or similar concept as the image acquirer 40 illustrated in FIG. 2, for example.

The sound pickup 150 detects sound or speech, including human vocalizations, around the terminal 100. For example, the sound pickup 150 may detect sound or speech as air vibrations via a diaphragm, for example, and convert the detected air vibrations into an electrical signal. Typically, the sound pickup 150 may include any acoustic device to convert sound into an electrical signal, such as a mike (microphone). In one embodiment, the sound pickup 150 may detect sound of the participant Mg in the home RL illustrated in FIG. 1, for example. The sound (electrical signal) detected by the sound pickup 150 may be inputted into the controller 110, for example. Accordingly, the sound pickup 150 may be connected to the controller 110 in a wired and/or wireless way. Basically, the sound pickup 150 may have a configuration based on the same and/or similar concept as the sound pickup 50 illustrated in FIG. 2, for example.

The sound outputter 170 outputs sound or speech by converting into sound an electrical signal (audio signal) outputted from the controller 110. The sound outputter 170 may be connected to the controller 110 in a wired and/or wireless way. The sound outputter 170 may include any device that functions to output sound, such as a speaker (loudspeaker). In one embodiment, the sound outputter 170 may output sound detected by the sound pickup 50 of the first electronic device 1. In this case, the sound detected by the sound pickup 50 of the first electronic device 1 may be the sound of at least one among the participants Ma, Mb, Mc, and Md in the meeting room MR illustrated in FIG. 1. Basically, the sound outputter 170 may have a configuration based on the same and/or similar concept as the sound outputter 70 illustrated in FIG. 2, for example.

The display 190 may be a display device of any type, such as a liquid crystal display (LCD), an organic electro-luminescence (EL) panel, or an inorganic electro-luminescence (EL) panel, for example. Basically, the display 190 may have a configuration based on the same and/or similar concept as the display 90 illustrated in FIG. 2, for example. Various data necessary for displaying information on the display 190 may be supplied from the controller 110 or the storage 120, for example. Accordingly, the display 190 may be connected to the controller 110 or the like in a wired and/or wireless way.

The display 190 may also be a touchscreen display that functions as a touch panel to detect input by a finger of the participant Mg or a stylus, for example.

In one embodiment, the display 190 may display video based on a video signal transmitted from the first electronic device 1. The display 190 may display video of, for example, the participants Ma, Mb, Mc, Md, and the like captured by (the image acquirer 40 of) the first electronic device 1 as the video based on a video signal transmitted from the first electronic device 1. Displaying video of the participants Ma, Mb, Mc, Md, and the like on the display 190 of the terminal 100 enables the participant Mg illustrated in FIG. 1 to visually understand the situation of the participants Ma, Mb, Mc, Md, and the like in the meeting room MR away from the home RL, for example.

The display 190 may display unmodified video of the participants Ma, Mb, Mc, Md, and the like captured by the first electronic device 1, for example. On the other hand, the display 190 may display images (for example, avatars) showing the participants Ma, Mb, Mc, Md, and the like as characters, for example.

In one embodiment, the terminal 100 may be a device designed for a specific purpose, as described above. On the other hand, in one embodiment, the terminal 100 may include some of the functional units illustrated in FIG. 3, for example. In this case, the terminal 100 may be connected to another electronic device to supplement at least some of the functions of the other functional units illustrated in FIG. 3. The other electronic device may be a general-purpose device such as a smartphone, tablet, phablet, notebook computer (notebook PC or laptop), or computer (desktop), for example.

In particular, a device such as a smartphone or a notebook computer often has most if not all of the functional units illustrated in FIG. 3. Thus, in one embodiment, the terminal 100 may be a device such as a smartphone or a notebook computer. In this case, the terminal 100 may be a device such as a smartphone or a notebook computer with an installed application (program) for working together with the first electronic device 1.

The following describes operations by the first electronic device 1, the second electronic device 2, and the terminal 100 according to one embodiment. As illustrated in FIG. 1, the following description assumes a situation in which remote conferencing takes places in the meeting room MR, and the participant Mg participates from the home RL.

In other words, the first electronic device 1 according to one embodiment is installed in the meeting room MR and detects the sound of at least one among the participants Ma, Mb, Mc, and Md. The sound detected by the first electronic device 1 is transmitted to the terminal 100 installed in the home RL of the participant Mg. The terminal 100 outputs the sound of at least one among the participants Ma, Mb, Mc, and Md received from the first electronic device 1. Thus, the participant Mg can listen to the sound of at least one among the participants Ma, Mb, Mc, and Md.

The second electronic device 2 according to one embodiment is installed in the meeting room MR and can output at least one of a predetermined auditory effect or a predetermined visual effect, for example, to at least one among the participants Ma, Mb, Mc, and Md. In one embodiment, the second electronic device 2 may output a masking sound including an operating sound or an environmental sound, for example, as the predetermined auditory effect to at least one among the participants Ma, Mb, Mc, and Md. In one embodiment, the second electronic device 2 may output a light drawing the attention of the participant, for example, as the predetermined visual effect to at least one among the participants Ma, Mb, Mc, and Md.

On the other hand, the terminal 100 according to one embodiment is installed in the home RL of the participant Mg and detects the sound of the participant Mg. The sound detected by the terminal 100 is transmitted to the first electronic device 1 installed in the meeting room MR. The first electronic device 1 outputs the sound of the participant Mg received from the terminal 100. Thus, at least one among the participants Ma, Mb, Mc, and Md can listen to the sound of the participant Mg.

The following describes operations by the first electronic device 1, the second electronic device 2, and the terminal 100 according to one embodiment, mainly from the perspective of the first electronic device 1 and second electronic device 2. Operations by the first electronic device 1, the second electronic device 2, and the terminal 100 according to one embodiment may include roughly three phases. In other words, operations by the first electronic device 1, the second electronic device 2, and the terminal 100 according to one embodiment may include the following:
(1) user interface (hereinafter also referred to as UI) display phase;
(2) setting change phase; and
(3) sound output phase.
   The following further describes each of the phases.

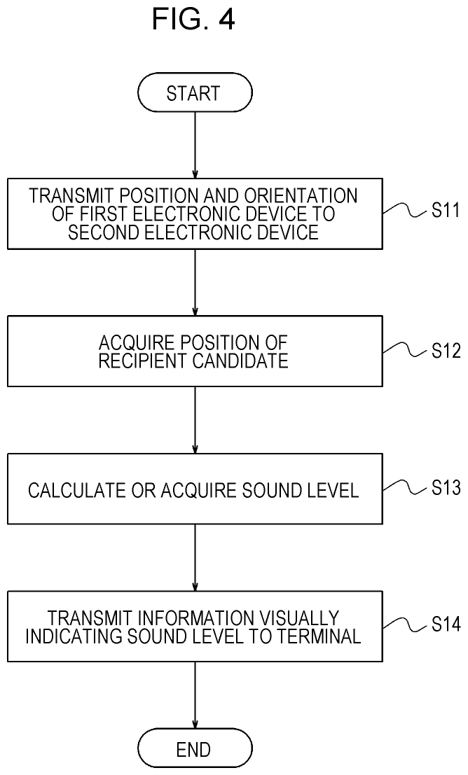

FIG. 4 is a flowchart for mainly describing the (1) UI display phase of the operations by the first electronic device 1, the second electronic device 2, and the terminal 100 according to one embodiment. FIG. 4 is a flowchart illustrating operations by the first electronic device 1 in the (1) UI display phase according to one embodiment.

The first electronic device 1, the second electronic device 2, and the terminal 100 are assumed to be connected in a wired and/or wireless way at the time when the operations illustrated in FIG. 4 start. The time when the operations illustrated in FIG. 4 start may be a time after the first electronic device 1 and the terminal 100 are connected and the first electronic device 1 and the second electronic device 2 are connected, such as a time before the start time of the remote conferencing, for example. In other words, the time when the operations illustrated in FIG. 4 start may be a time in a preparatory phase of the remote conferencing, for example. The operations illustrated in FIG. 4 enable each user to check and understand the status of the initial or current settings of the first electronic device 1.

When the operations illustrated in FIG. 4 start, the controller 10 of the first electronic device 1 transmits the position and orientation of the first electronic device 1 to the second electronic device 2 (step S11). In step S11, the controller 10 of the first electronic device 1 may transmit information indicating the position and orientation of the first electronic device 1 from the communicator 30 of the first electronic device 1 to the communicator 30 of the second electronic device 2. The controller 10 of the first electronic device 1 may acquire or receive the input of information on the position of the first electronic device 1 in advance. For example, the controller 10 of the first electronic device 1 may acquire the information by position information acquiring means such as GPS, or acquire the information by any other means. The controller 10 of the first electronic device 1 may acquire information on the orientation of the first electronic device 1 from the direction adjuster 80, for example, or acquire the information by any other means. The operations in step S11 are not necessarily performed first among the operations illustrated in FIG. 4, and may also be performed at any time during the operations illustrated in FIG. 4.

After step S11, the controller 10 of the first electronic device 1 may acquire the position, in the meeting room MR, of a candidate (hereinafter also referred to as the “recipient candidate”) to which to convey sound (the sound of the participant Mg) received from the terminal 100 (step S12). In the situation illustrated in FIG. 1, the recipient candidate may be each of the participants Ma, Mb, Mc, and Md. In other words, in step S12, the controller 10 of the first electronic device 1 acquires the positions of the participants Ma, Mb, Mc, and Md of the remote conferencing in the meeting room MR.

In step S12, the position of the recipient candidate may be stored as a predetermined position, for example, in the storage 20, for example. In one example, when chairs or the like in the meeting room MR are arranged in predetermined positions, the controller 10 of the first electronic device 1 can acquire the position of the recipient candidate in advance. When chairs or the like in the meeting room MR are arranged in predetermined positions but the position of the recipient candidate has not been acquired in advance, the controller 10 of the first electronic device 1 may also acquire the position via the communicator 30, for example. If the position of the recipient candidate has not been acquired in advance, the controller 10 of the first electronic device 1 may also detect user input of the position via a keyboard or other input device, for example.

In step S12, the controller 10 of the first electronic device 1 may also detect the position of the recipient candidate with the image acquirer 40, for example. The image acquirer 40 is capable of capturing an image of the surroundings of the first electronic device 1. Accordingly, the image acquirer 40 can capture video of the meeting participants Ma, Mb, Mc, and Md in the meeting room MR. When the image acquirer 40 includes a movable camera, the controller 10 of the first electronic device 1 may also capture an image of the surroundings of the first electronic device 1 while changing the direction of the image acquirer 40. When the direction adjuster 80 is capable of changing the orientation of the enclosure of the first electronic device 1, the controller 10 may also capture an image of the surroundings of the first electronic device 1 while changing the direction of the first electronic device 1.

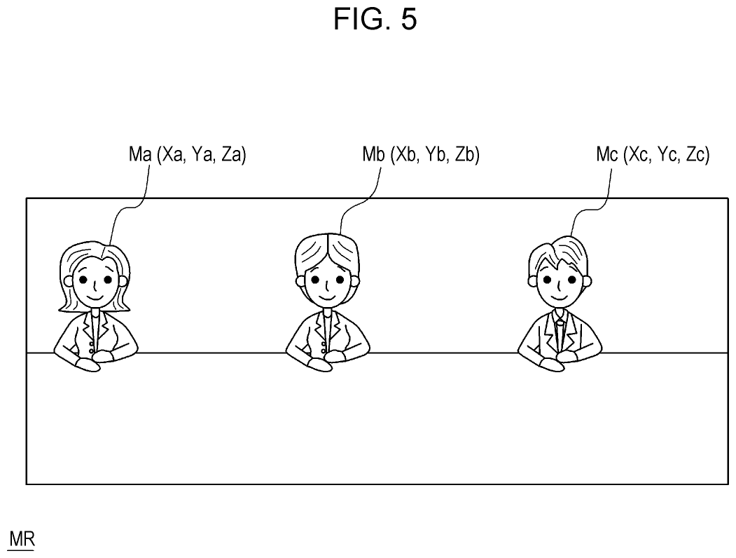

FIG. 5 is a diagram illustrating a portion of the meeting room MR captured by the image acquirer 40. For example, when the direction adjuster 80 is capable of changing the orientation of the first electronic device 1 360° in the horizontal direction, the image acquirer 40 can capture a 360° image of the inside of the meeting room MR like the one illustrated in FIG. 5, for example. FIG. 5 may illustrate a portion of a 360° image of the inside of the meeting room MR captured by the image acquirer 40. As illustrated in FIG. 5, the meeting participants Ma, Mb, and Mc are assumed to be in the image captured by the image acquirer 40.

In step S12, the controller 10 of the first electronic device 1 may acquire the positions of the meeting participants Ma, Mb, Mc, and the like (recipient candidates) from an image like the one illustrated in FIG. 5. In this case, the controller 10 of the first electronic device 1 may first use existing technology such as facial recognition, for example, to extract the recipient candidate(s) from an image like the one illustrated in FIG. 5. The controller 10 of the first electronic device 1 may estimate the actual position of the recipient candidate in the meeting room MR, for example, from the position of the recipient candidate in the angle of view on the basis of information such as the position and direction of the first electronic device 1 when the image acquirer 40 captured the recipient candidate. In this way, any of various known technologies may be adopted as the technique to estimate the position of a target from a captured image.

In step S12, as illustrated in FIG. 5, the controller 10 of the first electronic device 1 is assumed to estimate that the participant Ma is located at coordinates (Xa, Ya, Za), the participant Mb is located at coordinates (Xb, Yb, Zb), and the participant Mc is located at coordinates (Xc, Yc, Zc). In the same and/or similar manner, in step S12, the controller 10 of the first electronic device 1 may estimate the coordinates of the position of each participant on the basis of an image of the participant Md or the like, for example. For simplicity, the following describes only the participants Ma, Mb, and Mc from among the meeting participants Ma, Mb, Mc, and Md illustrated in FIG. 1.

After acquiring the position of the recipient candidate in step S12, the controller 10 of the first electronic device 1 calculates or acquires the sound level at the position of each recipient candidate (step S13). In other words, the controller 10 of the first electronic device 1 calculates or acquires information indicating how high the sound level is at the position of each recipient candidate in the meeting room MR. The sound level in this case is the level of the sound of the participant Mg that is received from the terminal 100 and outputted from the first electronic device 1.

In step S13, the controller 10 of the first electronic device 1 may calculate or acquire the sound level at each position on the basis of, for example, the position of the first electronic device 1, the direction of the sound outputter 70, and the position of each recipient candidate. The direction of the sound outputter 70 may be the direction of the directivity of sound outputted from the sound outputter 70. The “sound level” may be any of various types of indicators that the recipient candidate can recognize aurally. For example, the “sound level” may be the level of sound pressure or the like.

In step S13, the controller 10 of the first electronic device 1 may acquire the sound level at the position of each recipient candidate from data obtained in advance through a demonstration experiment or the like. Such data may be pre-stored in the storage 20, for example, or may be acquired as needed from outside the first electronic device 1 via the communicator 30.

On the other hand, in step S13, the controller 10 of the first electronic device 1 may calculate or estimate the sound level at the position of each recipient candidate from various data. For example, the controller 10 may calculate or estimate the sound level at the position of each recipient candidate on the basis of the position and direction of the first electronic device 1 (or the sound outputter 70), the sound pressure of sound outputted by the sound outputter 70, the position of each recipient candidate, and the like. In step S13, the controller 10 of the first electronic device 1 may also calculate or estimate the sound level at positions in a predetermined range surrounding each recipient candidate from various data.

After calculating or acquiring the sound level in step S13, the controller 10 of the first electronic device 1 transmits information visually indicating the sound level to the terminal 100 (step S14). In step S14, the controller 10 of the first electronic device 1 may generate information visually indicating the sound level and transmit the information from the communicator 30 of the first electronic device 1 to the communicator 130 of the terminal 100.

The information visually indicating the sound level may be, for example, information that visually suggests the degree to which the sound of the participant Mg outputted by the first electronic device 1 is aurally recognizable at the position of each recipient candidate.

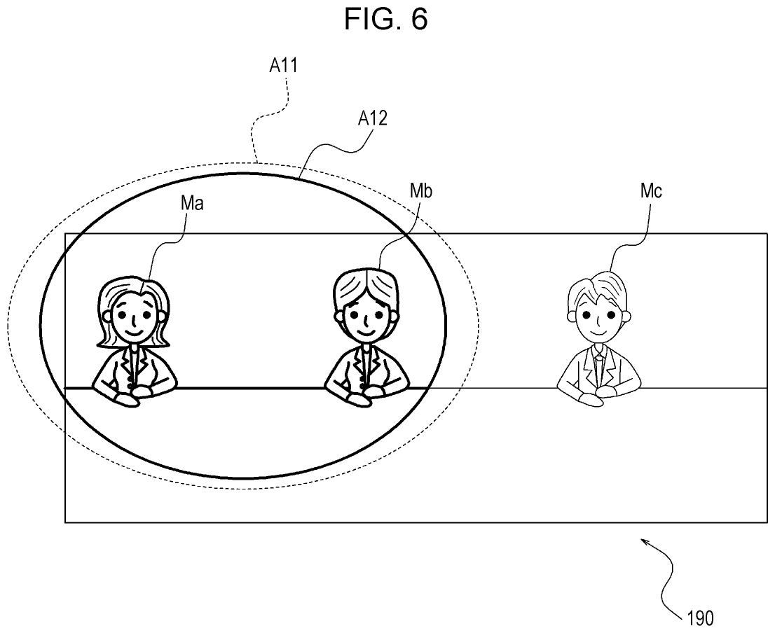

FIG. 6 is a diagram illustrating an example in which the terminal 100 receives information visually indicating the sound level transmitted in step S14, and displays the information on the display 190. The display of information as illustrated in FIG. 6 on the display 190 of the terminal 100 enables the participant Mg participating in the meeting from the home RL to understand in advance the degree to which an utterance by the participant Mg will be conveyed to which participant.

The participants Ma and Mb are displayed with emphasis inside an area A12 illustrated in FIG. 6. The emphasis may be used to indicate that, inside the area A12, the participants Ma and Mb can aurally recognize the sound of the participant Mg outputted by the first electronic device 1. The emphasis may be used to indicate that, inside an area A11 (excluding the inside of A12) illustrated in FIG. 6, a participant can, with difficulty, aurally recognize the sound of the participant Mg outputted by the first electronic device 1. The participant Mc is displayed without emphasis outside the area A11 illustrated in FIG. 6. The absence of emphasis may be used to indicate that, outside the area A11, the sound of the participant Mg outputted by the first electronic device 1 is mostly or completely unrecognizable by the participant Mc.

FIG. 6 visually indicates whether each recipient candidate can recognize the sound of the participant Mg, according to whether the images of the participants Ma, Mb, and Mc are displayed with or without emphasis. However, in one embodiment, the aspect for visually indicating whether a participant can recognize the sound of the participant Mg is not limited to whether the image of each recipient candidate is displayed with or without emphasis.

As one example of an aspect for visually indicating whether each recipient candidate can recognize the sound of the participant Mg, the controller 10 of the first electronic device 1 may make distinctions through shades of color used to display the images of the participants Ma, Mb, and Mc. As another example of an aspect for visually indicating whether each recipient candidate can recognize the sound of the participant Mg, the controller 10 of the first electronic device 1 may make distinctions through transparency levels used when displaying the images of the participants Ma, Mb, and Mc. As another example of an aspect for visually indicating whether each recipient candidate can recognize the sound of the participant Mg, the controller 10 of the first electronic device 1 may make distinctions through sizes used when displaying the images of the participants Ma, Mb, and Mc. As other aspects for visually indicating whether each recipient candidate can recognize the sound of the participant Mg, the controller 10 of the first electronic device 1 may make distinctions through any of various aspects to be used when displaying the images of the participants Ma, Mb, and Mc.

In this way, the controller 10 of the first electronic device 1 transmits, to the terminal 100, information visually indicating the level of sound of a human speaker (the participant Mg) at the position of a candidate that is to be the recipient of the sound of the human speaker. Thus, the terminal 100 can display, on the display 190, the level of sound of the human speaker at the position of a candidate that is to be the recipient of the sound of the human speaker.

The participant Mg can look at the display on the display 190 of the terminal 100 as illustrated in FIG. 6 and thereby understand that their own sound is aurally recognizable (in other words, can be heard) by the participants Ma and Mb. The participant Mg can also look at the display on the display 190 of the terminal 100 as illustrated in FIG. 6 and thereby understand that their own sound is not aurally recognizable (in other words, cannot be heard) by the participant Mc.

As described above, in the (1) UI display phase, the participant Mg can understand via the UI whether their own sound can be heard by the other meeting participants.

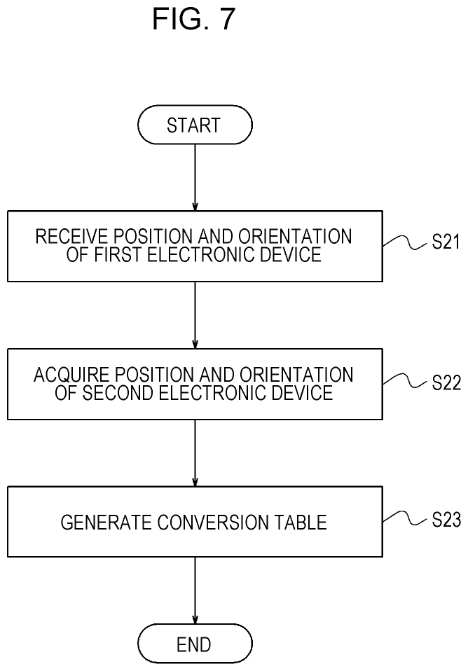

FIG. 7 is a flowchart illustrating operations that the second electronic device 2 according to one embodiment performs following the operations by the first electronic device 1 in the (1) UI display phase illustrated in FIG. 4.

When the operations illustrated in FIG. 7 start, the controller 10 of the second electronic device 2 receives information indicating the position and orientation of the first electronic device 1 (step S21). The information indicating the position and orientation of the first electronic device 1 received in step S21 may be the information transmitted in step S11 illustrated in FIG. 4.

After receiving the information indicating the position and orientation of the first electronic device 1 in step S21, the controller 10 of the second electronic device 2 acquires the position and orientation of the second electronic device 2 (step S22). In step S21, the controller 10 of the second electronic device 2 may acquire or receive the input of information on the position of the second electronic device 2 in advance. For example, the controller 10 of the second electronic device 2 may acquire the information by position information acquiring means such as GPS, or acquire the information by any other means. The controller 10 of the second electronic device 2 may acquire information on the orientation of the second electronic device 2 from the direction adjuster 80, for example, or acquire the information by any other means.

After acquiring the position and orientation of the second electronic device 2 in step S22, the controller 10 of the second electronic device 2 generates a conversion table for converting between a position with respect to the first electronic device 1 and a position with respect to the second electronic device 2 (step S23). For example, in step S23, the controller 10 of the second electronic device 2 may generate a conversion table for converting between coordinates in a coordinate system centered on the position of the first electronic device 1 and coordinates in a coordinate system centered on the position of the second electronic device 2. In this case, the controller 10 of the second electronic device 2 may align the orientation of the first electronic device 1 and the orientation of the second electronic device 2 before generating a conversion table for converting between coordinates in coordinate systems centered on the position of each.

The conversion table generated in step S23 allows the first electronic device 1 and the second electronic device 2 to each recognize the same recipient candidate as the same one. For example, the generated conversion table allows for converting the position of the participant Ma with respect to the first electronic device 1 to a position with respect to the second electronic device 2. As another example, the generated conversion table allows for converting the position of the participant Mb with respect to the second electronic device 2 to a position with respect to the first electronic device 1.

In step S23 illustrated in FIG. 7, the controller 10 of the second electronic device 2 is described as generating a conversion table. However, the controller 10 of the first electronic device 1 may also generate a conversion table. In this case, the controller 10 of the second electronic device 2 may acquire and transmit the position and orientation of the second electronic device 2 to the first electronic device 1, whereby the controller 10 of the first electronic device 1 may generate a conversion table.

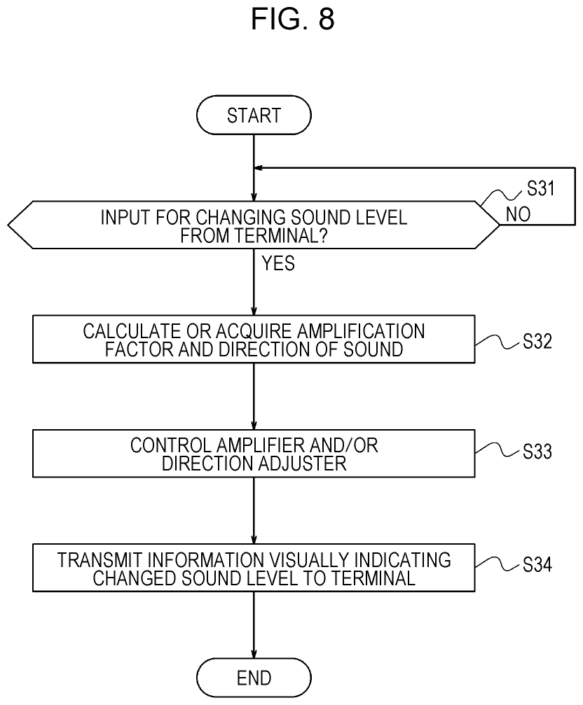

FIG. 8 is a flowchart for mainly describing the (2) setting change phase of the operations by the first electronic device 1, the second electronic device 2, and the terminal 100 according to one embodiment. FIG. 8 is a flowchart illustrating operations by the first electronic device 1 in the (2) setting change phase according to one embodiment.

Remote conferencing involving the first electronic device 1 and the terminal 100 may or may not have started at the time when the operations illustrated in FIG. 8 start. The operations illustrated in FIG. 8 enable a human speaker, namely the participant Mg, to choose the participant(s) who will be able to aurally recognize (in other words, hear) the sound of the participant Mg.

When the operations illustrated in FIG. 8 start, the controller 10 of the first electronic device 1 determines whether input for changing the sound level is received from the terminal 100 (step S31). As an example, assume that in step S31, the participant Mg uses the terminal 100 to enter input for changing the sound level at the position of a recipient candidate. In response, the terminal 100 transmits the input via the communicator 130 to the communicator 30 of the first electronic device 1. In this case, the controller 10 of the first electronic device 1 may determine that input for changing the sound level is received from the terminal 100.

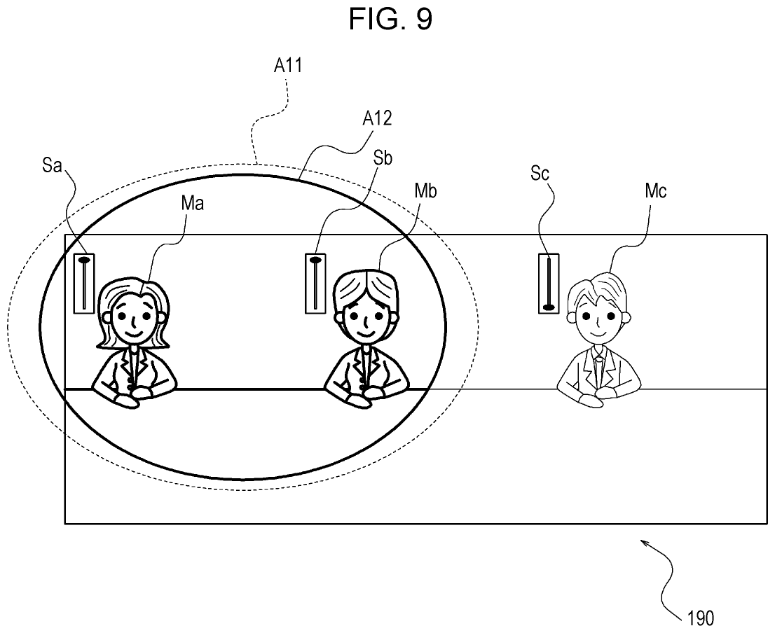

Upon receiving input for changing the sound level from the terminal 100 in step S31, the controller 10 of the first electronic device 1 may transmit, to the terminal 100, information for displaying a screen like the one illustrated in FIG. 9, for example, on the display 190 of the terminal 100. In this case, the controller 10 of the first electronic device 1 may transmit information for displaying a screen like the one illustrated in FIG. 9 from the communicator 30 to the communicator 130 of the terminal 100.

FIG. 9 is a diagram illustrating a screen on the display 190 of the terminal 100. The screen illustrated in FIG. 9 is used to receive input for changing the sound levels at the positions of recipient candidates. FIG. 9 is a diagram illustrating sliders on the screen of the display 190 illustrated in FIG. 6. The sliders enable changing of the sound level for each recipient candidate. The controller 110 may display the screen illustrated in FIG. 9 when, for example, the participant Mg enters predetermined input on the terminal 100, such as when the participant Mg touches the display 190 of the terminal 100 or touches any of the recipient candidates on the display 190 of the terminal 100. The participant Mg can change the sound level at the position of each recipient candidate by performing a touch operation on the slider displayed at the position of each recipient candidate.

For example, the participant Mg can change the sound level at the position of the participant Ma by operating a slider Sa corresponding to the participant Ma displayed on the display 190. The participant Mg can change the sound level at the position of the participant Mb by operating a slider Sb corresponding to the participant Mb displayed on the display 190. The participant Mg can change the sound level at the position of the participant Mc by operating a slider Sc corresponding to the participant Mc displayed on the display 190.

In FIG. 9, the slider Sa corresponding to the participant Ma is at a maximum. The slider Sa in this case indicates that the sound of the participant Mg is sufficiently aurally recognizable (in other words, sufficiently heard) by the participant Ma. In FIG. 9, the slider Sb corresponding to the participant Mb is also at a maximum. The slider Sb in this case indicates that the sound of the participant Mg is also sufficiently aurally recognizable (in other words, sufficiently heard) by the participant Mb. In FIG. 9, the slider Sc corresponding to the participant Mc is at a minimum. The slider Sc in this case indicates that the sound of the participant Mg is not aurally recognizable (in other words, not heard) by the participant Mc.

If the controller 10 of the first electronic device 1 does not receive input for changing the sound level from the terminal 100 in step S31, the controller 10 of the first electronic device 1 may stand by until receiving input for changing the sound level. If the controller 10 of the first electronic device 1 does not receive input for changing the sound level from the terminal 100 in step S31, the controller 10 of the first electronic device 1 may also end the operations illustrated in FIG. 8. On the other hand, if the controller 10 of the first electronic device 1 receives input for changing the sound level from the terminal 100 in step S31, the controller 10 of the first electronic device 1 calculates or acquires the amplification factor and the direction of sound (step S32).

In step S32, the controller 10 of the first electronic device 1 calculates or acquires the amplification factor and direction of sound for achieving the changed sound level. The “amplification factor” may be an amplification factor that the amplifier 60 uses to amplify an audio signal of a human speaker. The “direction of sound” may be the direction of sound of a human speaker, adjusted by the direction adjuster 80. The controller 10 of the first electronic device 1 may acquire the amplification factor and direction of sound for achieving the changed sound level from data obtained in advance through a demonstration experiment or the like. Such data may be pre-stored in the storage 20, for example, or may be acquired as needed from outside the electronic device 1 via the communicator 30. The controller 10 of the first electronic device 1 may also calculate the amplification factor and direction of sound for achieving the changed sound level from various data. For example, the controller 10 of the first electronic device 1 may calculate the amplification factor and direction of sound for achieving the changed sound level on the basis of the position and direction of the first electronic device 1 (or the sound outputter 70), the sound pressure of sound outputted by the sound outputter 70, the position of each recipient candidate, and the like.

After calculating or acquiring the amplification factor and direction of sound in step S32, the controller 10 of the first electronic device 1 controls at least one of the amplifier 60 or the direction adjuster 80 such that the amplification factor and direction of sound are achieved (step S33). In step S33, the controller 10 does not necessarily control at least one of the amplifier 60 or the direction adjuster 80 in cases where at least one of the amplification factor or the direction of sound is already achieved.

After controlling the amplifier 60 and/or the direction adjuster 80 in step S33, the controller 10 of the first electronic device 1 transmits information visually indicating the changed sound level to the terminal 100 (step S34). In step S34, the controller 10 may generate information visually indicating the changed sound level and transmit the information from the communicator 30 of the first electronic device 1 to the communicator 130 of the terminal 100. In the same and/or similar manner as the information illustrated in step S13 of FIG. 4, the information visually indicating the sound level may be, for example, information that visually suggests the degree to which the sound of the participant Mg outputted by the first electronic device 1 is aurally recognizable at the position or the like of each recipient candidate.

In step S34, the controller 10 of the first electronic device 1 may calculate or estimate the sound level at the position of each recipient candidate from various data. For example, the controller 10 of the first electronic device 1 may calculate or estimate the sound level at the position of each recipient candidate on the basis of the position and direction of the first electronic device 1 (or the sound outputter 70), the sound pressure of sound outputted by the sound outputter 70, the position of each recipient candidate, and the like. In step S34, the controller 10 of the first electronic device 1 may also calculate or estimate the sound level at positions in a predetermined range surrounding each recipient candidate from various data.

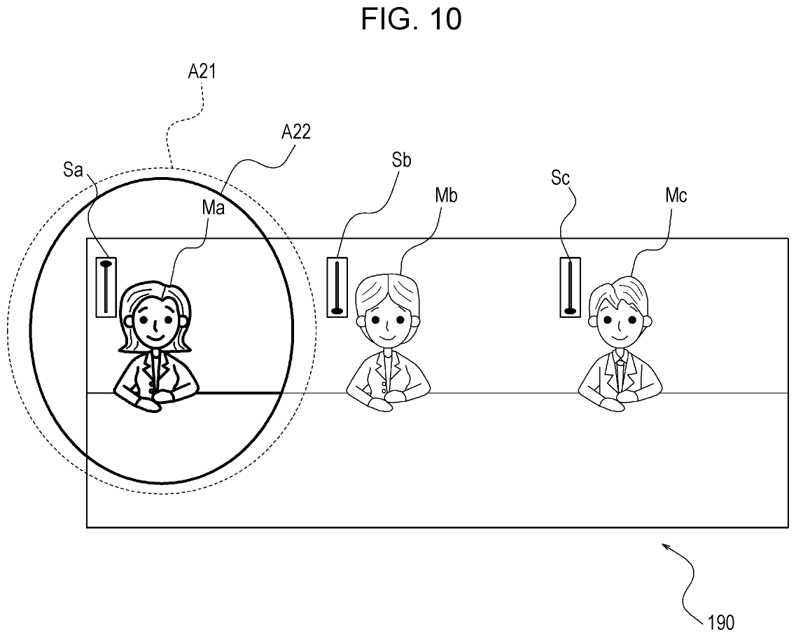

FIG. 10 is a diagram illustrating an example in which the terminal 100 receives information visually indicating the sound level transmitted in step S34, and displays the information on the display 190. The display of information as illustrated in FIG. 10 on the display 190 of the terminal 100 enables the participant Mg participating in the meeting from the home RL to understand in advance the degree to which an utterance by the participant Mg will be conveyed to which participant.

The participant Ma is displayed with emphasis inside an area A22 illustrated in FIG. 10. The emphasis may be used to indicate that, inside the area A22, the participant Ma can aurally recognize the sound of the participant Mg outputted by the first electronic device 1. The emphasis may be used to indicate that, inside an area A21 (excluding the inside of A22) illustrated in FIG. 10, a participant can, with difficulty, aurally recognize the sound of the participant Mg outputted by the first electronic device 1. The participants Mb and Mc are displayed without emphasis outside the area A21 illustrated in FIG. 10. The absence of emphasis may be used to indicate that, outside the area A21, the sound of the participant Mg outputted by the first electronic device 1 is mostly or completely unrecognizable by the participants Mb and Mc.

As illustrated in FIG. 9, the participant Mg can operate the slider Sb corresponding to the participant Mb displayed on the display 190 of the terminal 100. For example, the participant Mg can bring the slider Sb to a minimum. Accordingly, as illustrated in FIG. 10, the participant Mg can visually understand the state of the slider Sb corresponding to the participant Mb displayed on the display 190 of the terminal 100. For example, the participant Mg can visually understand that the slider Sb is at a minimum. In other words, FIG. 9 illustrates a situation in which the participant Mb can hear the sound of the participant Mg. However, FIG. 10 illustrates a situation in which the participant Mb cannot hear the sound of the participant Mg.

Some plausible situations may not allow for optionally differentiating whether each recipient candidate can aurally recognize (in other words, hear or not hear) sound outputted from the sound outputter 70, depending on the sound pressure and/or direction of the outputted sound, for example. In such cases, the controller 10 of the first electronic device 1 may, for example, disallow movement of the slider Sb corresponding to the participant Mb illustrated in FIG. 9, or cause the slider Sb to go back to some degree after being moved. As another example, when the participant Mg attempts to move the slider Sb corresponding to the participant Mb illustrated in FIG. 9, the controller 10 may make the action more difficult for the participant Mg to perform. As another example, when the participant Mg moves the slider Sb corresponding to the participant Mb illustrated in FIG. 9, the controller 10 may cause another slider, such as the slider Sa corresponding to the participant Ma, for example, to move together with the slider Sb.

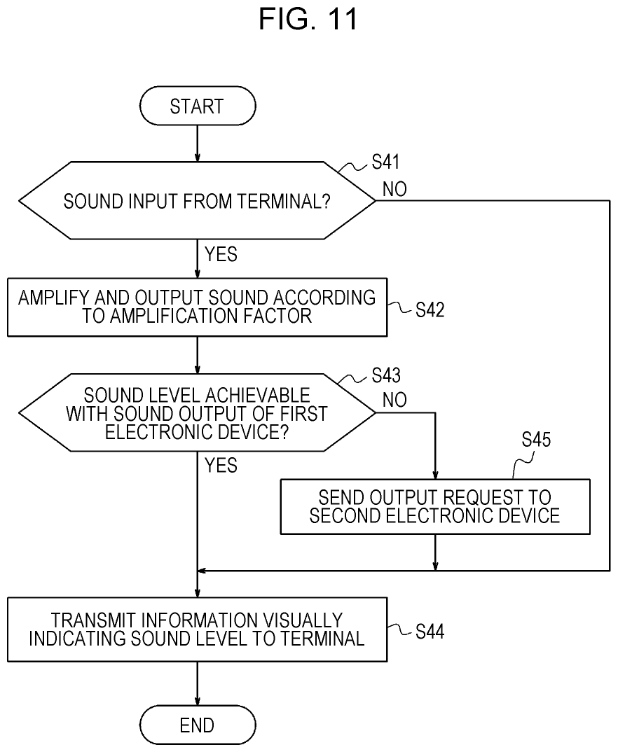

FIG. 11 is a flowchart for mainly describing the (3) sound output phase of the operations by the first electronic device 1, the second electronic device 2, and the terminal 100 according to one embodiment. FIG. 11 is a flowchart illustrating operations by the electronic device 1 in the (3) sound output phase according to one embodiment.

At the time when the operations illustrated in FIG. 11 start, the operations illustrated in FIGS. 4, 7, and 8 may be complete and remote conferencing involving the first electronic device 1 and the terminal 100 may have started, for example. The operations illustrated in FIG. 11 enable a human speaker, namely the participant Mg, to speak so that their own sound is aurally recognizable according to the settings in FIG. 8.

When the operations illustrated in FIG. 11 start, the controller 10 of the first electronic device 1 determines whether sound input is received from the terminal 100 (step S41). The sound input from the terminal 100 may be input based on the sound of the participant Mg detected by the sound pickup 150 of the terminal 100.

When sound input is received from the terminal 100 in step S41, the controller 10 of the first electronic device 1 controls the amplifier 60 to amplify the sound input according to the amplification factor calculated or acquired in step S32 of FIG. 8 (step S42). In step S42, the controller 10 of the first electronic device 1 controls the sound outputter 70 to output the sound amplified according to the amplification factor.

After outputting sound in step S42, the controller 10 of the first electronic device 1 determines whether the sound level at the position of the recipient candidate is achievable using only the sound output of the first electronic device 1 (step S43). The sound level to be determined as achievable or not in step S43 may be, for example, the sound level changed in step S31 of FIG. 8. For example, in step S43, the controller 10 of the first electronic device 1 may determine whether a sound level that would be difficult to recognize by the participant Mb is achievable using the sound output of the first electronic device 1, as with the position of the participant Mb illustrated in FIGS. 9 and 10. In step S43, the controller 10 of the first electronic device 1 may determine whether the sound level at the position of the recipient candidate is achievable on the basis of the level and direction of the sound to be outputted from the first electronic device 1 and the level and direction of sound to be outputted from the second electronic device 2.

In step S43, if the sound level is determined to be achievable using the sound output of the first electronic device 1, the controller 10 of the first electronic device 1 transmits, to the terminal 100, information visually indicating the level of sound to be outputted (step S44). In step S44, the controller 10 of the first electronic device 1 may generate information visually indicating the level of sound to be outputted from the first electronic device 1 and transmit the information from the communicator 30 of the first electronic device 1 to the communicator 130 of the terminal 100. In the same and/or similar manner as the information illustrated in step S34 of FIG. 8, the information visually indicating the level of sound may be, for example, information that visually suggests the degree to which the sound of the participant Mg outputted by the first electronic device 1 is aurally recognizable at the position of each recipient candidate.

In step S44, the controller 10 of the first electronic device 1 may calculate or estimate the sound level at the position of each recipient candidate from various data. For example, the controller 10 of the first electronic device 1 may calculate or estimate the sound level at the position of each recipient candidate on the basis of the position and direction of the first electronic device 1 (or the sound outputter 70), the sound pressure of sound outputted by the sound outputter 70, the position of each recipient candidate, and the like. In step S44, the controller 10 of the first electronic device 1 may also calculate or estimate the sound level at positions in a predetermined range surrounding each recipient candidate from various data.

On the other hand, in step S43, only a sound level that is recognizable at the position of the participant Mb may be achievable in some cases, even if the controller 10 of the first electronic device 1 adjusts the level (for example, the amplification factor) and/or the direction of sound to be outputted from the sound outputter 70. In such cases, the controller 10 of the first electronic device 1 transmits to the second electronic device 2 a request to output predetermined sound or speech (step S45). Hereinafter, the request to output predetermined sound or speech that is transmitted to the second electronic device 2 is referred to as the “output request” where appropriate. In step S45, the controller 10 of the first electronic device 1 may transmit the output request from the communicator 30 of the first electronic device 1 to the communicator 30 of the second electronic device 2.

In step S45, the output request transmitted to the second electronic device 2 may contain information including, for example, the position of a person who is undesirable as a recipient (hereinafter also referred to as a “non-recipient”) from among the recipient candidates, for example. The output request may also contain information indicating a target sound level at the position of the non-recipient, for example. The output request may also contain information indicating the level of sound to be outputted from the first electronic device 1, for example. The output request may also contain information indicating the level, at the position of the non-recipient, of sound to be outputted from the first electronic device 1, for example. The output request may also contain information indicating a target level, at the position of the non-recipient, of sound or speech to be outputted from the second electronic device 2, for example.

After transmitting the output request to the second electronic device 2 in step S45, the controller 10 of the first electronic device 1 may execute the process illustrated in step S44.

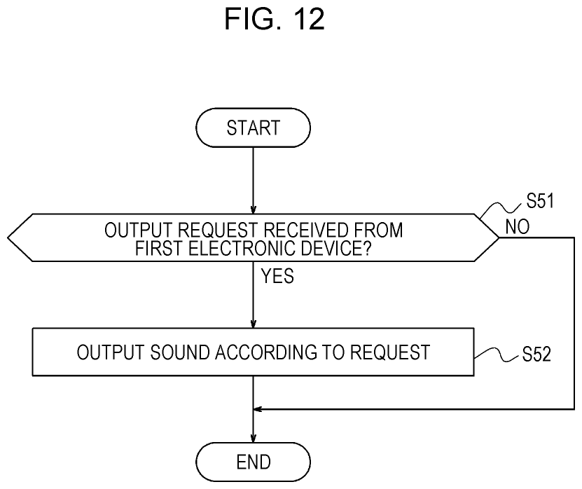

FIG. 12 is a flowchart illustrating operations that the second electronic device 2 according to one embodiment performs following the operations by the first electronic device 1 in the (3) sound output phase illustrated in FIG. 11.

When the operations illustrated in FIG. 12 start, the controller 10 of the second electronic device 2 receives an output request (step S51). The output request received in step S51 may be the output request transmitted in step S45 illustrated in FIG. 11.

Upon receiving the output request in step S51, the controller 10 of the second electronic device 2 controls the sound outputter 70 of the second electronic device 2 to output predetermined sound or speech according to the output request (step S52). The predetermined sound or speech outputted in step S52 may be, for example, a masking sound such as noise outputted to the non-recipient. Causing the second electronic device 2 to output sound or speech according to the output request can reduce the risk of the non-recipient recognizing the sound outputted by the first electronic device 1, even in cases where the non-recipient could recognize the sound outputted by the first electronic device 1 alone, for example.

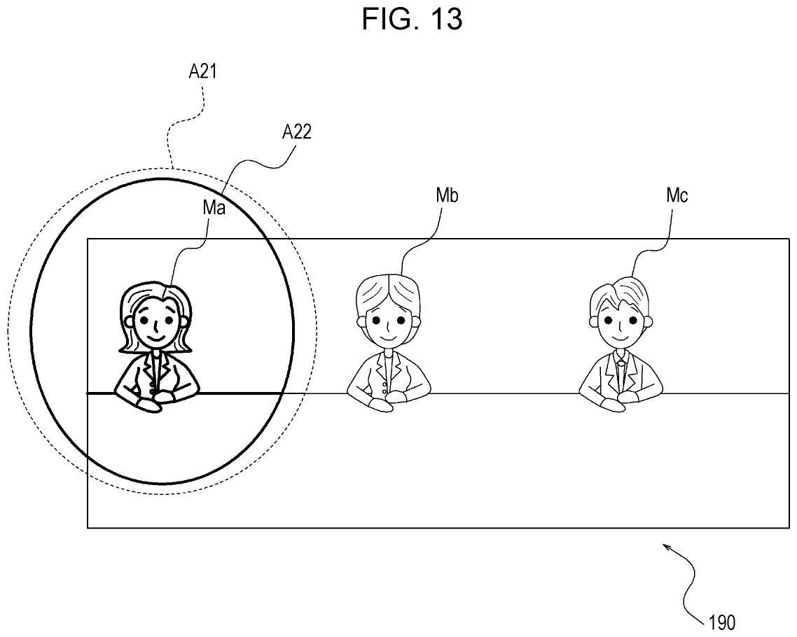

FIG. 13 is a diagram illustrating an example in which the terminal 100 receives information visually indicating the sound level transmitted in step S44 illustrated in FIG. 11, and displays the information on the display 190. The display of information as illustrated in FIG. 13 on the display 190 of the terminal 100 enables the participant Mg participating in the meeting from the home RL to understand the degree to which an utterance by the participant Mg will be conveyed to which participant.

The participant Ma is displayed with emphasis inside the area A22 illustrated in FIG. 13. The emphasis may be used to indicate that, inside the area A22, the participant Ma can aurally recognize the sound of the participant Mg outputted by the first electronic device 1. The emphasis may be used to indicate that, inside the area A21 (excluding the inside of A22) illustrated in FIG. 13, a participant can, with difficulty, aurally recognize the sound of the participant Mg outputted by the first electronic device 1. The participants Mb and Mc are displayed without emphasis outside the area A21 illustrated in FIG. 13. The absence of emphasis may be used to indicate that, outside the area A21, the sound of the participant Mg outputted by the first electronic device 1 is mostly or completely unrecognizable by the participants Mb and Mc.

In this way, in the first electronic device 1 according to one embodiment, the controller 10 sets an amplification factor that the amplifier 60 uses to amplify an audio signal of a human speaker. The “amplification factor” may be an amplification factor that the amplifier 60 uses to amplify an audio signal of a human speaker. The controller 10 of the first electronic device 1 controls the second electronic device 2 to output at least one of an auditory effect or a visual effect on the basis of input at the terminal 100 for changing the level of sound at the position of a candidate that is to be a recipient of the sound. The second electronic device 2 may output at least one of a predetermined auditory effect or a predetermined visual effect. The visual effect that the second electronic device 2 outputs is described later.

The controller 10 of the first electronic device 1 may set and also change the direction of sound adjusted by the direction adjuster 80. The “direction of sound” may be the direction of sound of a human speaker that the direction adjuster 80 adjusts.

The controller 10 of the first electronic device 1 may transmit a request (output request) for the second electronic device 2 to output at least one of an auditory effect or a visual effect. The controller 10 may transmit the output request from the communicator 30 of the first electronic device 1 to the second electronic device 2. In this case, the controller 10 of the first electronic device 1 may transmit the output request to the second electronic device 2 when the sound of a human speaker to be outputted from the sound outputter 70 is not at or below a predetermined level at the position of a predetermined candidate (for example, the non-recipient) among the recipient candidates. The controller 10 of the first electronic device 1 may also transmit the output request to the second electronic device 2 when the sound of a human speaker to be outputted from the sound outputter 70 exceeds a predetermined level at the position of a predetermined candidate (for example, the non-recipient) among the recipient candidates.

In the first electronic device 1 according to one embodiment, the sound outputter 70 may output an audio signal as the sound of a human speaker. The audio signal in this case may be the audio signal of a human speaker that the communicator 30 receives from the terminal 100. In one embodiment, the controller 10 of the first electronic device 1 may set the volume of sound of a human speaker that the sound outputter 70 is to output. In this case, when the level of sound of the human speaker is changed at the terminal 100, the controller 10 of the first electronic device 1 changes, or leaves unchanged, the volume of sound of the human speaker that the sound outputter 70 is to output. In one embodiment, the first electronic device 1 may, for example, change the amplification factor with the amplifier 60 to thereby change the volume of sound of the human speaker that the sound outputter 70 is to output.

As described above, in the meeting room MR, the first electronic device 1 can output the sound of the participant Mg present in the home RL. In the meeting room MR, the first electronic device 1 can convey sound to only the recipient candidate(s) to whom the participant Mg wants to convey sound. In other words, according to the first electronic device 1 according to one embodiment, a human speaker, namely the participant Mg, can choose the participant(s) who will be able to aurally recognize (in other words, hear) the sound of the participant Mg. Consequently, the first electronic device 1 according to one embodiment can have improved functionality for enabling communication between multiple locations.

### Other Embodiments

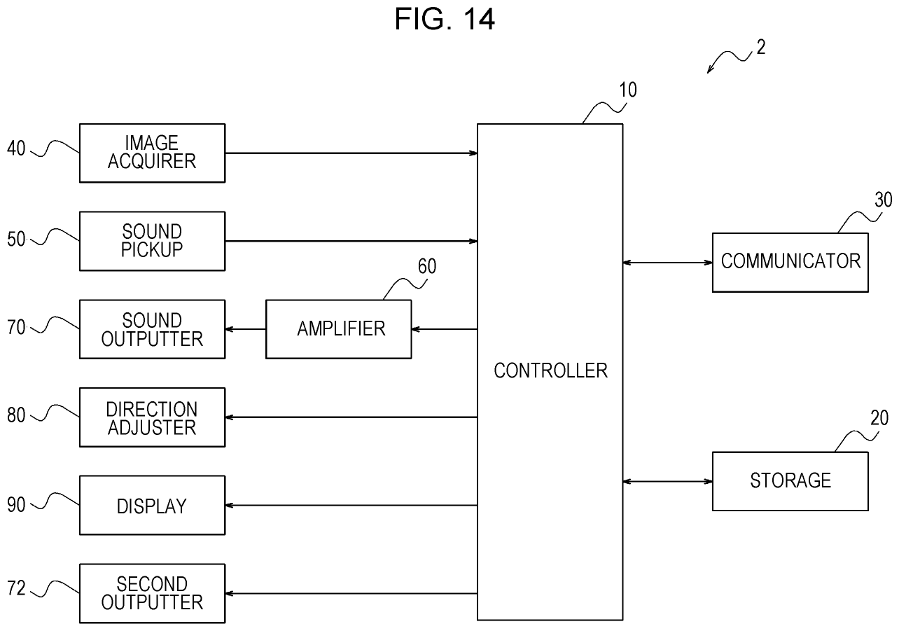

FIG. 14 is a block diagram schematically illustrating a functional configuration of a second electronic device 2 according to another embodiment. The following describes an example of the configuration of the second electronic device 2 according to one embodiment, with focus on the points that differ from the second electronic device 2 described above.

Compared to the second electronic device 2 with the same configuration as the first electronic device 1 illustrated in FIG. 2, the second electronic device 2 illustrated in FIG. 14 includes a second outputter 72. The second outputter 72 outputs a predetermined auditory effect. The predetermined auditory effect may be any of various types of sound or speech, such as environmental sound, noise, an operating sound of the second electronic device 2, a sound effect that draws human attention, or sound different from the sound of the participant Mg, for example.

The second outputter 72 may be provided inside or outside the enclosure of the second electronic device 2. When the second outputter 72 is provided inside the enclosure of the second electronic device 2, a mechanism may be provided to change the direction of the second outputter 72 and/or the directivity of the auditory effect outputted from the second outputter 72. When the second outputter 72 is provided outside the enclosure of the second electronic device 2, a mechanism likewise may be provided to change the direction of the second outputter 72 and/or the directivity of the auditory effect outputted from the second outputter 72. When the second outputter 72 is provided outside the enclosure of the second electronic device 2, (more than one of) the second outputter 72 may be readied to correspond with each of the recipient candidates, such as the participants Ma, Mb, Mc, and Md, for example. The second outputter 72 may also be placed in a position different from the sound outputter 70, so that the second outputter 72 can produce a different auditory effect different from the sound outputter 70.

When the sound of the participant Mg outputted in step S42 of FIG. 11 would also be conveyed to the non-recipient, or when such conveyance of sound is a concern, for example, the second electronic device 2 may output from the second outputter 72 a predetermined auditory effect directed toward the non-recipient. As a plausible example, suppose that in the situation illustrated in FIG. 9, the participant Mg designates the participant Mb as the non-recipient and lowers, to some degree, the slider Sb displayed on the display 190 of the terminal 100, but the sound level at the position of the participant Mb does not fall to or below a predetermined level. In such a case, instead of lowering the level of sound to be outputted from the sound outputter 70, or in addition to such lowering, the controller 10 of the second electronic device 2 may control the second outputter 72 to output a predetermined auditory effect.

In this case, the controller 10 of the second electronic device 2 may control the second outputter 72 to output a predetermined auditory effect in step S52 of FIG. 12, for example. This arrangement can reduce the risk that the sound of the participant Mg will also be conveyed to the non-recipient. Consequently, the second electronic device 2 according to one embodiment can have improved functionality for enabling communication between multiple locations.

In yet another embodiment, the second outputter 72 provided to the second electronic device 2 may also output an ultrasonic wave as the predetermined auditory effect. The second outputter 72 may output an ultrasonic wave to a predetermined part of the non-recipient or to a predetermined part in the vicinity of the non-recipient, thereby drawing the attention of the non-recipient to reflections of the ultrasonic wave. As a result, the non-recipient may direct less attention to the sound of the participant Mg.

### OTHER EMBODIMENTS

In cases like the above, a predetermined visual effect may also be outputted instead of, or together with, a predetermined auditory effect.

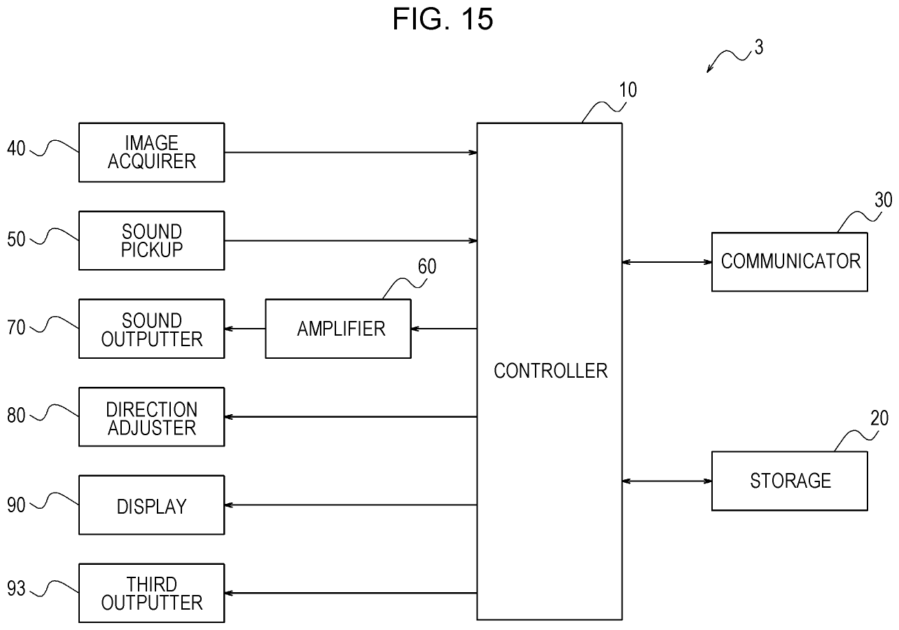

FIG. 15 is a block diagram schematically illustrating a functional configuration of a second electronic device 3 according to another embodiment. The following describes an example of the configuration of the second electronic device 3 according to one embodiment, with focus on the points that differ from the first electronic device 1 or the second electronic device 2 described above.

Compared to the second electronic device 2 illustrated in FIG. 14, the electronic device 3 illustrated in FIG. 15 includes a third outputter 93. The third outputter 93 outputs a predetermined visual effect. The predetermined visual effect may be light from an LED or a laser beam, for example. The predetermined visual effect may be produced in any of various patterns. For example, light like the above may be emitted only momentarily or made to blink at a predetermined speed.

The third outputter 93 may be provided inside or outside the enclosure of the second electronic device 3. When the third outputter 93 is provided inside the enclosure of the second electronic device 3, a mechanism may be provided to change the direction of the third outputter 93 and/or the directivity of the visual effect outputted from the third outputter 93. When the third outputter 93 is provided outside the enclosure of the second electronic device 3, a mechanism likewise may be provided to change the direction of the third outputter 93 and/or the directivity of the visual effect outputted from the third outputter 93. When the third outputter 93 is provided outside the enclosure of the second electronic device 3, (more than one of) the third outputter 93 may be readied to correspond with each of the recipient candidates, such as the participants Ma, Mb, Mc, Md, Me, and Mf, for example.

When the sound of the participant Mg outputted in step S42 of FIG. 11 would also be conveyed to the non-recipient, or when such conveyance of sound is a concern, for example, the second electronic device 3 may output from the third outputter 93 a predetermined visual effect directed toward the non-recipient.

In this case, the controller 10 of the second electronic device 3 may control the third outputter 93 to output a predetermined auditory effect in step S52 of FIG. 12, for example. This arrangement can reduce the risk that the sound of the participant Mg will also be conveyed to the non-recipient. Consequently, the second electronic device 3 according to one embodiment can have improved functionality for enabling communication between multiple locations.

As described above, the second electronic device 2 (or 3) according to one embodiment may include a controller 10, a communicator 30, and an outputter (70, 72, 93). The communicator 30 communicates with a first electronic device 1 (other electronic device) that outputs sound of a human speaker. The outputter (70, 72, 93) outputs at least one of a predetermined auditory effect or a predetermined visual effect. The controller 10 controls the outputter (70, 72, 93) to output at least one of an auditory effect or a visual effect on the basis of a request from the first electronic device 1. The outputter (70, 72) may output a predetermined sound wave. The outputter 72 may output a predetermined ultrasonic wave. The outputter 93 may output predetermined light.

The foregoing describes embodiments according to the present disclosure on the basis of the drawings and examples, but note that a person skilled in the art could easily make various alternatives or revisions on the basis of the present disclosure. Consequently, it should be understood that the scope of the present disclosure includes these alternatives or revisions. For example, the functions and the like included in each component, each step, and the like may be rearranged in logically non-contradictory ways. A plurality of components, steps, or the like may be combined into one or subdivided. The foregoing describes embodiments of the present disclosure mainly in terms of a device, but an embodiment of the present disclosure may also be implemented as a method including steps to be executed by each component of a device. An embodiment of the present disclosure may also be implemented as a method or program to be executed by a processor provided in a device, or as a storage medium on which the program is recorded. It should be understood that the scope of the present disclosure includes these embodiments.

The embodiments described above are not limited solely to embodiments of the first electronic device 1 and/or the second electronic device. For example, the embodiments described above may also be carried out as a method of controlling a device like the first electronic device 1 and/or the second electronic device. As a further example, the embodiments described above may also be carried out as a program to be executed by a device like the first electronic device 1 and/or the second electronic device. Such a program is not necessarily limited to being executed only in the first electronic device 1 and/or the second electronic device. For example, such a program may also be executed in a smartphone or other electronic device that works together with the first electronic device 1 and/or the second electronic device.

The embodiments described above can be carried out from any of various perspectives. For example, one embodiment may be carried out as a system that includes the first electronic device 1, the second electronic device, and the terminal 100. As another example, one embodiment may be carried out as another electronic device (such as a server or a control device, for example) capable of communicating with each of the first electronic device 1, the second electronic device, and the terminal 100. In this case, the other electronic device such as a server, for example, may execute at least some of the functions and/or operations of the first electronic device 1 described in the foregoing embodiments. More specifically, the other electronic device such as a server, for example, may set (instead of the first electronic device 1) the amplification factor to be used when the first electronic device 1 amplifies an audio signal to output as sound. In this case, the first electronic device 1 can output the audio signal as sound by amplifying the audio signal according to the amplification factor set by the other electronic device such as a server, for example. One embodiment may be carried out as a program to be executed by the other electronic device such as a server, for example. One embodiment may be carried out as a system that includes the first electronic device 1, the second electronic device 2, the terminal 100, and the other electronic device (third electronic device) such as a server described above.

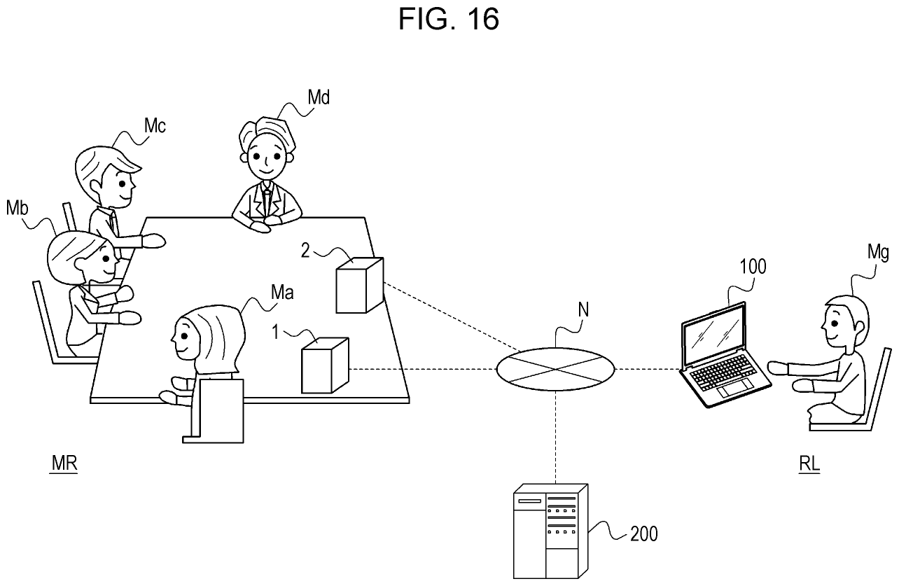

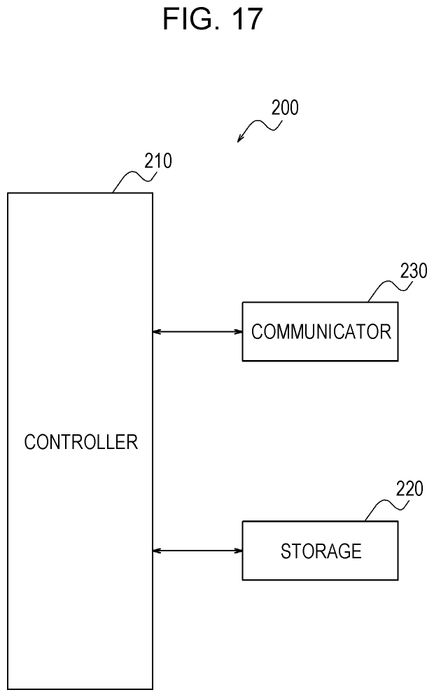

For example, the third electronic device (other electronic device such as a server, for example) described above may be a component like the electronic device 200 illustrated in FIG. 16. In this case, as illustrated in FIG. 17, the electronic device 200 may include a controller 210, storage 220, and a communicator 230, for example. The controller 210 may have a configuration and/or function that is the same as, and/or similar to, the controller 10 and/or the controller 110. The storage 220 may have a configuration and/or function that is the same as, and/or similar to, the storage 20 and/or the storage 120. The communicator 230 may have a configuration and/or function that is the same as, and/or similar to, the communicator 30 and/or the communicator 130. The controller 210 of the electronic device 200 may perform operations or processes that are the same as, and/or similar to, at least some of the steps illustrated in FIGS. 4, 7, 8, 11, and 12, for example.

### REFERENCE SIGNS

1 first electronic device
2 second electronic device
10 controller
20 storage
30 communicator
40 image acquirer
50 sound pickup
60 amplifier
70 sound outputter
72 second outputter
80 direction adjuster
90 display
93 third outputter
100 terminal
110 controller
120 storage
130 communicator
140 image acquirer
150 sound pickup
170 sound outputter
190 display
200 electronic device

1. An electronic device comprising:
a communicator that communicates with a terminal of a human speaker and communicates with another electronic device that outputs at least one of a predetermined auditory effect or a predetermined visual effect;
a sound outputter that outputs an audio signal of the human speaker that the communicator receives from the terminal as sound of the human speaker; and
a controller that sets a volume of the sound that the sound outputter outputs, wherein
the controller controls the other electronic device to output at least one of the auditory effect or the visual effect when a level of the sound at a position of a candidate that is to be a recipient of the sound is changed at the terminal.

2. The electronic device according to claim 1, further comprising:
a direction adjuster that adjusts a direction of the sound to be outputted by the sound outputter, wherein
the controller sets the direction of the sound to be adjusted by the direction adjuster and, when the level of the sound is changed at the terminal, changes the direction of the sound.

3. The electronic device according to claim 1, wherein the controller transmits, from the communicator to the other electronic device, a request for the other electronic device to output at least one of the auditory effect or the visual effect.

4. The electronic device according to claim 3, wherein the controller transmits the request from the communicator to the other electronic device when the sound to be outputted from the sound outputter exceeds a predetermined level at the position of a predetermined candidate among candidates that are to be recipients of the sound.

5. A non-transitory computer-readable recording medium storing computer program instructions, which when executed by an electronic device, cause the electronic device to execute the following:
communicating with a terminal of a human speaker;
communicating with another electronic device that outputs at least one of a predetermined auditory effect or a predetermined visual effect;
outputting an audio signal of the human speaker received from the terminal as sound of the human speaker;
setting a volume of the sound to be outputted in the outputting step; and
controlling the other electronic device to output at least one of the auditory effect or the visual effect when a level of the sound at a position of a candidate that is to be a recipient of the sound is changed at the terminal.

6. An electronic device comprising:
a communicator that communicates with another electronic device that outputs sound of a human speaker;
an outputter that outputs at least one of a predetermined auditory effect or a predetermined visual effect; and
a controller that controls the outputter to output at least one of the auditory effect or the visual effect on a basis of a request from the other electronic device.

7. The electronic device according to claim 6, wherein the outputter outputs a predetermined sound wave.

8. The electronic device according to claim 6, wherein the outputter outputs a predetermined ultrasonic wave.

9. The electronic device according to claim 6, wherein the outputter outputs predetermined light.

10. A non-transitory computer-readable recording medium storing computer program instructions, which when executed by an electronic device, cause the electronic device to execute the following:
communicating with another electronic device that outputs sound of a human speaker;
outputting at least one of a predetermined auditory effect or a predetermined visual effect; and
causing at least one of the auditory effect or the visual effect to be outputted in the outputting step on a basis of a request from the other electronic device.

11. A system including first and second electronic devices capable of communicating with one another,
the first electronic device comprising:
a sound outputter that outputs an audio signal of a human speaker received from a terminal of the human speaker as sound of the human speaker; and
a controller that sets a volume of the sound that the sound outputter outputs,
the controller controlling the second electronic device to output at least one of a predetermined auditory effect or a predetermined visual effect when a level of the sound at a position of a candidate that is to be a recipient of the sound is changed at the terminal,
the second electronic device comprising:
an outputter that outputs at least one of a predetermined auditory effect or a predetermined visual effect; and
a controller that controls the outputter to output at least one of the auditory effect or the visual effect on a basis of a request from the first electronic device.

12. A system including a first electronic device, a second electronic device, and a terminal of a human speaker,
the terminal and the first electronic device being configured to communicate with one another,
the first electronic device and the second electronic device being configured to communicate with one another,
the first electronic device comprising:
a sound outputter that outputs an audio signal of a human speaker received from the terminal as sound of the human speaker; and
a controller that sets a volume of the sound that the sound outputter outputs,
the controller controlling the second electronic device to output at least one of a predetermined auditory effect or a predetermined visual effect when a level of the sound at a position of a candidate that is to be a recipient of the sound is changed at the terminal,
the second electronic device comprising:
an outputter that outputs at least one of a predetermined auditory effect or a predetermined visual effect; and
a controller that controls the outputter to output at least one of the auditory effect or the visual effect on a basis of a request from the first electronic device, and
the terminal comprising:
a sound pickup that picks up sound of the human speaker; and
a controller that performs control to transmit an audio signal of the human speaker to the first electronic device and to transmit, to the first electronic device, input for changing a level of the sound at a position of a candidate that is to be a recipient of the sound.

13. An electronic device capable of communicating with each of a terminal of a human speaker, a first electronic device that outputs an audio signal of the human speaker as sound of the human speaker, and a second electronic device that outputs at least one of a predetermined auditory effect or a predetermined visual effect,
the electronic device comprising a controller that sets a volume of the sound that the first electronic device outputs, wherein
when a level of the sound at a position of a candidate that is to be a recipient of the sound is changed at the terminal, the controller changes, or leaves unchanged, the volume of the sound, controls the first electronic device to output the sound, and controls the second electronic device to output at least one of the auditory effect or the visual effect.

14. A non-transitory computer-readable recording medium storing computer program instructions, which when executed by an electronic device, cause the electronic device to execute the following:
communicating with a terminal of a human speaker, a first electronic device that outputs an audio signal of the human speaker as sound of the human speaker, and a second electronic device that outputs at least one of a predetermined auditory effect or a predetermined visual effect;
setting a volume of the sound that the first electronic device outputs;
changing, or leaving unchanged, the volume of the sound when a level of the sound at a position of a candidate that is to be a recipient of the sound is changed at the terminal;
controlling the first electronic device to output the sound; and
controlling the second electronic device to output at least one of the auditory effect or the visual effect.

15. A system including a terminal of a human speaker, a first electronic device, a second electronic device, and a third electronic device,
the third electronic device being configured to communicate with the terminal, the first electronic device, and the second electronic device,
the terminal comprising:
a sound pickup that picks up sound of the human speaker; and
a controller that performs control to transmit an audio signal of the human speaker to the third electronic device and to transmit, to the third electronic device, input for changing a level of the sound at a position of a candidate that is to be a recipient of the sound,
the first electronic device comprising:
a sound outputter that outputs an audio signal of a human speaker received from the terminal as sound of the human speaker,
the second electronic device comprising:
an outputter that outputs at least one of a predetermined auditory effect or a predetermined visual effect; and
a controller that controls the outputter to output at least one of the auditory effect or the visual effect on a basis of a request from the third electronic device, and
the third electronic device comprising:
a controller that sets a volume of the sound that the first electronic device outputs, wherein
when a level of the sound at a position of a candidate that is to be a recipient of the sound is changed at the terminal, the controller changes, or leaves unchanged, the volume of the sound, controls the first electronic device to output the sound, and controls the second electronic device to output at least one of a predetermined auditory effect or a predetermined visual effect.
